(19) United States
(12) Patent Application Publication
(10) Pub. No.: US 2023/0401245 A1
(43) Pub. Date: Dec. 14, 2023

(54) INFORMATION PROCESSING APPARATUS

(71) Applicant: Ryo IMAIZUMI, Tokyo (JP)

(72) Inventor: Ryo IMAIZUMI, Tokyo (JP)

(21) Appl. No.: 18/251,151

(22) PCT Filed: Nov. 1, 2021
(86) PCT No.: PCT/JP2021/040294

§ 371 Date: Apr. 28, 2023

(30) Foreign Application Priority Data
Oct. 30, 2020 (JP) 2020-182514

(51) Int. Cl. G06F 16/332

(52) U.S. Cl. CPC G06F 16/3329

(57) ABSTRACT

The purpose of the present invention is to enable manipulation of information which can be an origin for creating a new business model in which innovative information is reflected. An inference unit infers a type of “innovation” requested by a user based on a prior survey of the user. A question generation unit sets one or more questions. A keyword extraction unit extracts a plurality of first keywords from replies by the user to the one or more questions. A device determination unit extracts a conversion device to be applied to the first keywords, from a conversion device storage unit. A shift unit, by using the conversion device, converts each of the first keywords to a corresponding one of a plurality of second keywords. A contextualization unit generates details of one or more innovations by contextualizing at least a portion of the second keywords. Thus, the above-mentioned purpose is met.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/JP2021/040294, filed Nov. 1, 2021 entitled, “INFORMATION PROCESSING APPARATUS”, which claims priority to Japanese Patent Application No. 2020-182514, filed Oct. 30, 2020, all of which are incorporated herein by reference in their entirety.

### TECHNICAL FIELD

The present invention relates to an information processing apparatus.

### BACKGROUND ART

In recent years, advancement and development of technologies are significant in a wide variety of fields such as information technologies (IT) and genetic modification technologies. Along with such tendencies, business aspects have varied, and various business models have been proposed in not only such information technologies (IT) and genetic modification technologies, but also in a wide variety of industries. Along with those proposals, many technologies for proposing business models have been proposed (for example, see Patent Document 1). For example, Patent Document 1 describes a technology that relates to modeling of one type of business and that compares or contrasts business models with each other.
Patent Document 1: Japanese Unexamined Patent Application, Publication No. 2006-285955

### SUMMARY OF THE INVENTION

### Problems to be Solved by the Invention

However, conventional technologies including the technology described in Patent Document 1 merely enable comparison of existing business models with each other and examination of the effects of a combination of some of the existing business models. Therefore, creating a new business model that introduces innovative information such as user's original ideas and social reforms has not yet been envisaged.

In view of such situations as described above, the present invention represents a method of designing an innovation-specific business model with an object of enabling manipulation of information that may be an origin for creating a new business model in which innovative information is reflected.

### Means for Solving the Problems

To achieve the object described above, an information processing apparatus according to an aspect of the present invention includes an extraction portion that extracts one or more first keywords included in replies by a user to one or more predetermined questions that are set based on a thing that the user is recognizing as “innovation” and a type and a detail of “innovation” that the user desires, which are acquired through a prior survey on the user; a conversion portion that uses a predetermined conversion device and converts each of the one or more first keywords extracted by the extraction portion into each of one or more second keywords and a generation portion that generates a detail of innovation for the user based on the one or more second keywords outputted as a result of the conversion by the conversion portion.

### Effects of the Invention

According to the present invention, it is possible to manipulate information that may be an origin for creating a new business model in which innovative information is reflected.

### BRIEF DESCRIPTION OF THE DRAWINGS

FIG. 1 is a diagram illustrating an outline of a present service achieved by an information processing system in which an information processing apparatus according to an embodiment of the present invention is applied;

FIG. 2 is a diagram illustrating an example of a current situation check sheet used in the present service illustrated in FIG. 1;

FIG. 3 is a diagram illustrating an example of a table used in the present service illustrated in FIG. 1, indicating a correspondence relation among types of innovation, approaches, questions, and devices;

FIG. 4 is a graph visualizing a creation process of a detail of “innovation” using a conventional method;

FIG. 5 is a graph visualizing a creation process of a detail of “innovation” using the present service;

FIG. 6 is a graph visualizing a creation process of a detail of “business”, to which the creation process of a detail of “innovation” illustrated in FIG. 3 is applied;

FIG. 7 is a diagram illustrating a specific example indicating processes in steps SS31 to SS33 in the innovation creation process illustrated in FIG. 5;

FIG. 8 is a diagram illustrating a specific example indicating processes in steps SS34 to SS36 in the innovation creation process illustrated in FIG. 5;

FIG. 9 is a diagram illustrating an example of an interface presented to a user in a stage of expanding (diffusing) innovative means illustrated in FIG. 7;

FIG. 10 is a block diagram illustrating an example of a hardware configuration of the information processing apparatus according to the embodiment of the present invention;

FIG. 11 is a functional block diagram illustrating an example of a functional configuration pertaining to innovation creation support processing, among functional configurations of the information processing apparatus illustrated in FIG. 6;

FIG. 12 is a flowchart illustrating the innovation creation support processing executed by the information processing apparatus having the functional configuration illustrated in FIG. 11;

FIG. 13 is a flowchart illustrating divergence processing in a process that corresponds to a left side eye of cat's-eyes illustrated in FIG. 5 in divergence processing illustrated in FIG. 12;

FIG. 14 is a flowchart illustrating divergence processing in a process that corresponds to a right side eye of the cat's-eyes illustrated in FIG. 5 in the divergence processing illustrated in FIG. 12;

FIG. 15 is a diagram illustrating an example of a formula used in innovation making processing executed by the information processing apparatus illustrated in FIG. 11;

FIG. 16 is a diagram illustrating an example of information processing for generating or updating a device of “opposite” among devices used in the information processing apparatus having the functional configuration illustrated in FIG. 11;

FIG. 17 is a diagram illustrating an example of information processing for generating or updating a device of “equivalent” among the devices used in the information processing apparatus having the functional configuration illustrated in FIG. 11;

FIG. 18 is a diagram illustrating an example of information processing for generating or updating a device of “addition” in “addition and subtraction” among the devices used in the information processing apparatus having the functional configuration illustrated in FIG. 11; and

FIG. 19 is a diagram illustrating an example of information processing for generating or updating a device of “subtraction” in “addition and subtraction” among the devices used in the information processing apparatus having the functional configuration illustrated in FIG. 11.

### DETAILED DESCRIPTION OF THE INVENTION

An embodiment of the present invention will now be described herein with reference to the accompanying drawings.

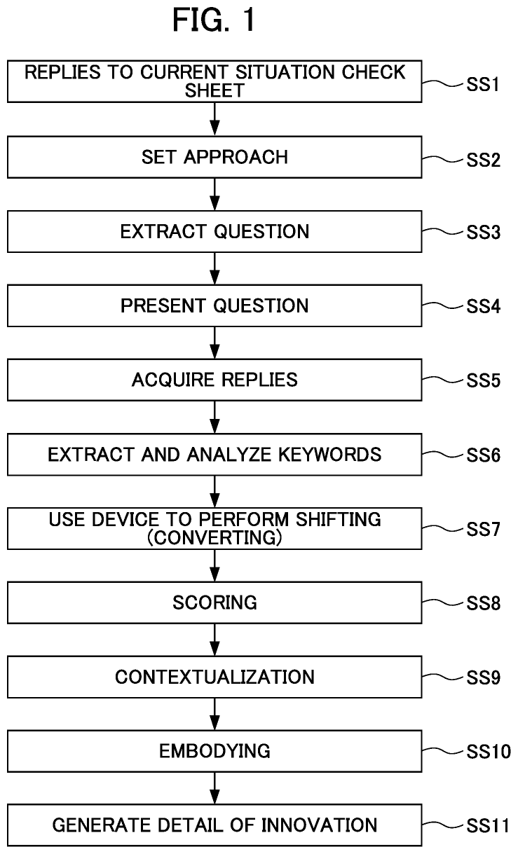

An outline of a service (hereinafter referred to as “the present service”) that is subject to the application of an information processing apparatus according to the embodiment of the present invention will first be described. FIG. 1 is a diagram illustrating the outline of the present service achieved by an information processing system in which the information processing apparatus according to the embodiment of the present invention is applied.

The present service represents a service provided by a service provider (not illustrated) to a user (not illustrated). The present service includes provision of a detail of innovation and also a support for having an innovative idea, for example. The users receiving the present service include natural persons desiring provision of a detail of innovation and service providers having received such requests from the natural persons, for example.

Note herein that terms such as “innovation” and “innovative” used in the present specification are utilized as those that mean that new ways of thinking and new technologies are introduced to generate new values to bring renovations, refurbishments, and reforms to individuals and societies, or are utilized as those that mean such ways of thinking and actions. As to “innovation”, it is possible to set such types as “product innovation” and “service innovation”. As will be described later in detail, “product innovation” among them refers to a type of “innovation” in the field of “object” that is tangible. On the other hand, “service innovation” refers to a type of “innovation” in the field of services pertaining to “experience” that is not tangible but is able to be seen and/or felt.

As described above, the terms “innovation” and “innovative” fall, when used, within the scope of an ambiguous concept having various meanings. Therefore, what specific things “innovation” and “innovative” are perceived to represent differs for each person. For example, depending on differences in a way of perceiving those points such as “what is renovated”, “which directionality it is renovated”, and “how much it is changed as a result of renovation”, there are differences in what is perceived as “innovation”. Furthermore, some users may face difficulties in clarifying what kind of a thing or an action are they perceiving as “innovation” and what kind of a detail of “innovation” do they desire.

Therefore, the present service first performs a step of clarifying what kind of a thing is the user recognizing as “innovation”. Then, a detail that is predicted to be recognized by the user as “innovation” is proposed as the detail of “innovation”.

As illustrated in step SS1 in FIG. 1, in the present service, a “current situation check sheet” is adopted as a method of inferring what kind of a thing is the user recognizing as “innovation” and what kinds of a type and a detail of “innovation” does the user desire. Note that the “current situation check sheet” is not limited to be in the form of a paper medium, as long as text and other forms of information are visible by the user. For example, one that is displayed on a predetermined display may be applied. That is, the provider of the present service presents the current situation check sheet to the user to clarify, based on replies (for example, keywords included in there) by the user to the current situation check sheet, what kind of a thing is the user recognizing as “innovation” and what kinds of a type and a detail of “innovation” does the user desire. Furthermore, information pertaining to the user, which is acquired separately and which includes the profile of the user and other information (hereinafter referred to as “user information”) is also utilized as information for clarifying what kind of a thing is the user recognizing as “innovation” and what kinds of a type and a detail of “innovation” does the user desire.

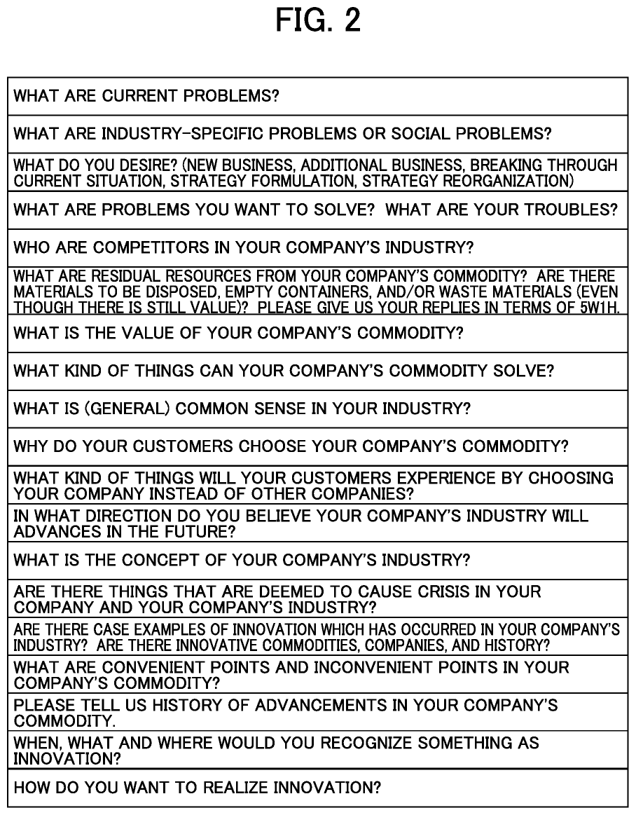

For example, the current situation check sheet presented to the user includes a plurality of check details, as illustrated in FIG. 2. FIG. 2 is a diagram illustrating an example of the current situation check sheet used in the present service illustrated in FIG. 1. Specific details of the check details include, for example, “What are current problems?”, “What are industry-specific problems or social problems?”, “What do you desire? (new business, additional business, breaking through current situation, strategy formulation, strategy reorganization)”, “What are the problems you want to solve? What are your troubles?”, “Who are competitors in your company's industry?”, and “What are residual resources from your company's commodity? Are there materials to be disposed, empty containers, and/or waste materials (even though there is still value)? Please give us your replies in terms of 5w1h.”. Furthermore, the current situation check sheet may include check details that differ from those that aim to extract specific and other facts from the user to visualize problems that have not yet been visualized. Specifically, for example, as illustrated in FIG. 2, such a check detail that does not directly recall innovation at a glance such as “Please tell us the history of advancements in your company's commodity.” may be included. Thereby, the user is able to freely reply to the presented check details. Note that, as will be described later in detail, other examples of check details presented to the user are as illustrated in FIG. 2.

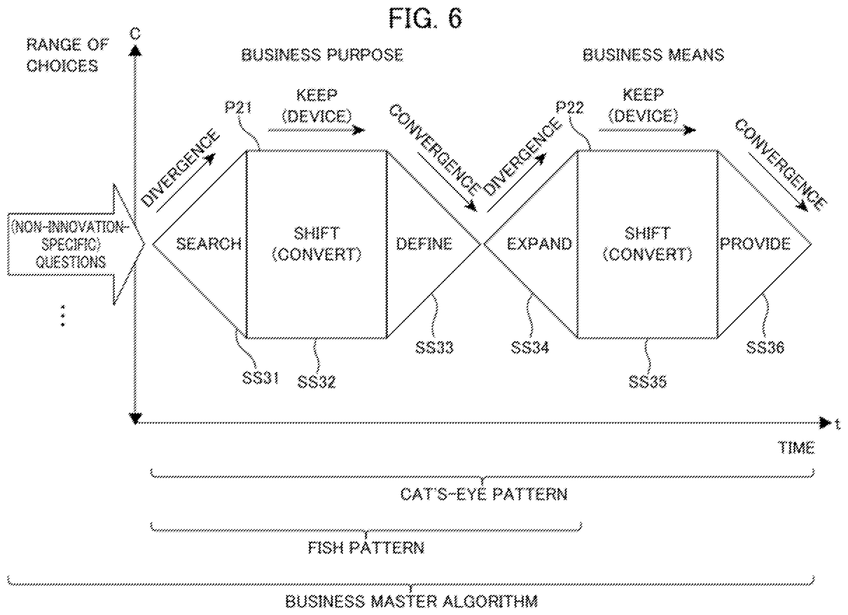

For the plurality of check details included in the current situation check sheet as described above, replies by the user are respectively received. For example, replies are inputted through manipulations by the user on a predetermined information processing apparatus (specifically, for example, an information processing apparatus 1 that will be described later and that is illustrated in FIG. 6) and received by the information processing apparatus.

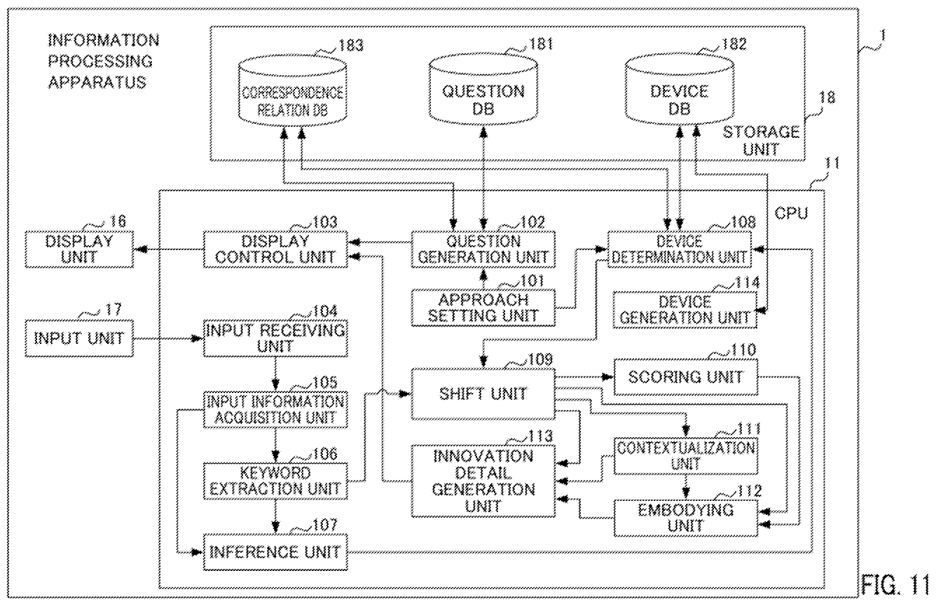

Specifically, for example, it is assumed herein that a reply by the user to a check detail of “What are current problems?” in the current situation check sheet is “I can't picture an image new product of tissue paper”. In this case, in the information processing apparatus (specifically, for example, the information processing apparatus 1 that will be described later and that is illustrated in FIG. 11), keywords such as “tissue paper”, “new product”, “image”, and “can't picture” are extracted and analyzed. As a result, for example, a determination result of “This user is at least recognizing developing a new product as ‘innovation’.” is outputted. Furthermore, for example, it is assumed herein that a reply by the user to a check detail of “How do you want to realize innovation?” is “I want to produce and sell in the market a new one that hasn't been seen before.”. In this case, in the information processing apparatus (specifically, for example, the information processing apparatus 1 that will be described later and that is illustrated in FIG. 11), keywords such as “hasn't been seen before”, “new one”, “produce and sell in the market” are extracted and analyzed. As a result, for example, an analysis result of “This user is at least recognizing unveiling a new one in the market as ‘innovation’.” is outputted. Furthermore, since the term “hasn't been seen before” corresponds to, in other words, “not belong to those that everyone has already seen before and that everyone already commonly knows”, such a determination result in which the user is recognizing a type of innovation that defies common sense, i.e., “disruptive innovation, as ‘innovation’” is outputted. Note that types of innovation such as disruptive innovation will be described later in detail.

In this way, as illustrated in steps SS2 and SS3 in FIG. 1, it is clarified what kind of a thing is the user recognizing as “innovation” and what kinds of a type and a detail of “innovation” does the user desire, and then “questions” based on an “approach” are presented to the user.

Although what kind of a process is used to generate questions to be presented to the user is not particularly limited, questions are produced in the present service in such a process as described below. In the information processing apparatus (specifically, for example, the information processing apparatus 1 that will be described later and that is illustrated in FIG. 11), “an ‘approach’ serving as a condition for extracting questions to be presented to the user” is first set. For example, it is assumed herein that various questions have been distributed around a circular column (a trunk of a tree), and some of the various questions, which are distributed on a surface (an approach) within a predetermined range that is cut out of the circular column at a predetermined angle at which a saw has entered, are presented to the user. The “predetermined angle” at which the saw has entered and the “predetermined range” to be cut out in this case are able to vary in accordance with a thing that the user is recognizing as “innovation” and a type and a detail of “innovation” that the user desires. That is, it is necessary that more appropriate questions are presented to the user to propose, to the user, the questions that are in line with the type and the detail that the user desires among those that the user is recognizing as “innovation”.

Therefore, an “approach” serving as a condition for extracting more appropriate questions is set in accordance with a thing that the user is recognizing as “innovation” and a type and a detail of “innovation” that the user desires.

As types of “innovation”, there are “service innovation” and “product innovation” described above, for example. The type of “product innovation” refers to a type of “innovation” in the field of “object” that is tangible. The type of “service innovation” refers to a type of “innovation” in the field of services pertaining to “experience” that is not tangible but is able to be seen and/or felt. Furthermore, as types of “innovation”, there are “disruptive innovation”, “social innovation”, and “business model innovation”, for example. The type of “disruptive innovation” refers to a type of “innovation” that defies conventional common sense and sense of value. The type of “social innovation” refers to a type of “innovation” that enables social problems to be solved. The type of “business model innovation” refers to a type of “innovation” that enables a reduction of processes in methods of manufacturing commodities and methods of providing services, for example.

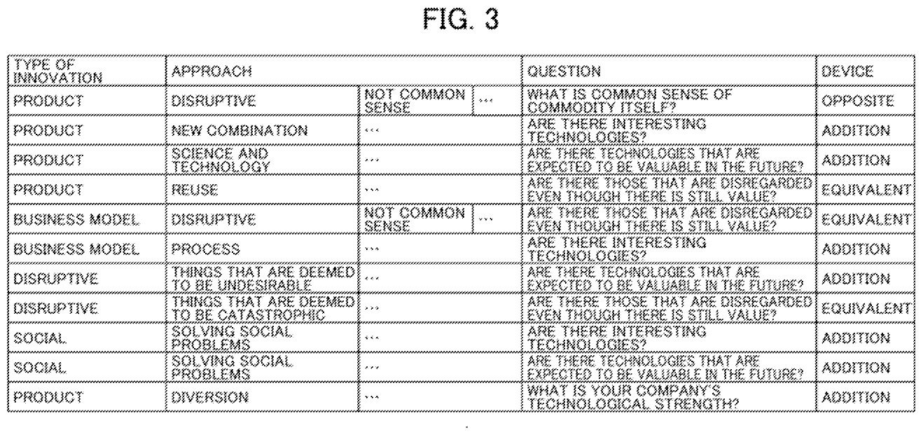

Although a specific method of setting an “approach” is not particularly limited, it is assumed herein that such a method is adopted in which a type of innovation and an “approach” are associated with each other, for the purpose of description. That is, it is assumed herein that such a method is adopted in which a table (a correspondence relation) illustrated in FIG. 3 is stored beforehand in the information processing apparatus (specifically, for example, the information processing apparatus 1 that will be described later and that is illustrated in FIG. 11), and an “approach” is set based on the table (the correspondence relation). FIG. 3 is a diagram illustrating an example of the table used in the present service illustrated in FIG. 1, indicating the correspondence relation among types of innovation, approaches, questions, and devices.

Specific examples of approaches will be described with reference to the table illustrated in FIG. 3. Note that the questions and the devices included in the table illustrated in FIG. 3 will be described later.

Specifically, for example, in the information processing apparatus (specifically, for example, the information processing apparatus 1 that will be described later and that is illustrated in FIG. 11), it is assumed herein that a result of inference of “disruptive innovation is recognized as ‘innovation’” is outputted based on the current situation check sheet and user information. In this case, in the information processing apparatus (specifically, for example, the information processing apparatus 1 that will be described later and that is illustrated in FIG. 11), “things that are deemed to be undesirable” and “things that are deemed to be catastrophic” that are associated with “disruptive innovation” in the table illustrated in FIG. 3 are set as “approaches”, for example.

Furthermore, for example, it is assumed herein that the user is identified as a manufacturer of tissue paper via the user information separately acquired, and, in the information processing apparatus (specifically, for example, the information processing apparatus 1 that will be described later and that is illustrated in FIG. 11), a result of inference of “A detail of ‘innovation’ that the user desires is tissue paper representing product (object).”, i.e., a result of inference of “product innovation on tissue paper is recognized as ‘innovation’.” is outputted based on this user information and the current situation check sheet. In this case, in the information processing apparatus (specifically, for example, the information processing apparatus 1 that will be described later and that is illustrated in FIG. 11), “disruptive”, “new combination”, “science and technology”, and “reuse” that are associated with “product innovation” in the table illustrated in FIG. 3 are set as “approaches”, for example.

Furthermore, for example, it is assumed herein that, even if details of the user information separately acquired are not enough, and even if it is not possible to identify the product that the user is manufacturing, in the information processing apparatus (specifically, for example, the information processing apparatus 1 that will be described later and that is illustrated in FIG. 11), a result of inference, which is acquired via the current situation check sheet, that a detail of “innovation” that the user desires is “product that the user is manufacturing”, i.e., a result of inference of “product innovation on the product that the user is manufacturing is recognized as “innovation”” is outputted. In this case, in the information processing apparatus (specifically, for example, the information processing apparatus 1 that will be described later and that is illustrated in FIG. 11), “disruptive”, “new combination”, “science and technology”, and “reuse” that are associated with “product innovation” in the table illustrated in FIG. 3 are set as “approaches”, for example.

Furthermore, for example, in the information processing apparatus (specifically, for example, the information processing apparatus 1 that will be described later and that is illustrated in FIG. 11), it is assumed herein that a result of inference, which is acquired via the current situation check sheet, of “The user recognizes one as innovation if it includes solving social problems.” is outputted. In this case, in the information processing apparatus (specifically, for example, the information processing apparatus 1 that will be described later and that is illustrated in FIG. 11), a keyword of “solving social problems” included in the determination result is recognized to be included in the “approaches” in the table illustrated in FIG. 3, and the “solving social problems” is set as an “approach”.

Furthermore, for example, in the information processing apparatus (specifically, for example, the information processing apparatus 1 that will be described later and that is illustrated in FIG. 11), it is assumed herein that a result of inference, which is acquired via the current situation check sheet, of “Tissue paper representing the user's product (object) is recognized as a detail of ‘innovation’ that the user desires.” is outputted. In this case, an “approach” may be set such that questions pertaining to “tissue paper that is the user's product (object)” are extracted. That is, in the table illustrated in FIG. 3, there is a question of “What is the common sense of the commodity itself?”. Therefore, in the information processing apparatus (specifically, for example, the information processing apparatus 1 that will be described later and that is illustrated in FIG. 11), “disruptive” that is associated with the question in the table illustrated in FIG. 3 is set as an “approach”.

Furthermore, for example, even if details of the user information separately acquired are not enough, and if it is not possible to identify the product that the user is manufacturing, in the information processing apparatus (specifically, for example, the information processing apparatus 1 that will be described later and that is illustrated in FIG. 11), it is assumed herein that a result of inference, which is acquired via the current situation check sheet, that a detail of “innovation” that the user desires corresponds to “product that the user is manufacturing” is outputted. In this case, an “approach” may be set such that questions pertaining to “product that the user is manufacturing” are extracted. That is, in the table illustrated in FIG. 3, there is a question of “What is the common sense of the commodity itself?”. Therefore, in the information processing apparatus (specifically, for example, the information processing apparatus 1 that will be described later and that is illustrated in FIG. 11), “disruptive” that is associated with the question in the table illustrated in FIG. 3 is set as an “approach”.

The method of setting an “approach” has been described with reference to the setting method using the table (the correspondence relation) illustrated in FIG. 3. However, the present invention is not particularly limited to the method described above. Specifically, for example, when “questions” are actually extracted or generated based on an “approach” that is set through a certain method based on a current situation check sheet and user information, and a detail of “innovation” is actually recommended to the user through a procedure described later based on the “questions”, an evaluation (for example, a score described later) by the user is acquired. In this case, when a set of the “details of the current situation check sheet and user information”, the “approach”, the “questions”, the recommended “detail of innovation”, and the “user's evaluation” is used as learning data, predetermined machine learning is performed, such a model that outputs an “approach” when “details of the current situation check sheet and user information” are inputted is generated or updated. It is thus possible to adopt such a method that uses the model to set an “approach”.

When one or more “approaches” are set in this way, one or more “questions” that is or are appropriate for presenting to the user is or are extracted or generated based on the one or more “approaches”. Note herein that a “question” refers to a query that is extracted or generated based on an “approach” and that is presented to the user. Furthermore, one reason why such a term “extract” or “generate” is used is that, although there may be cases where the questions are simply “extracted” since it is assumed herein that many questions are prepared beforehand in the table illustrated in FIG. 3 in this example, for example, there may also be cases where at least a portion of one or more questions is or are “generated” based on one or more “approaches”. Note that it is assumed herein that arranging at a degree that a keyword included in a question in the table illustrated in FIG. 3 is converted also falls within the meaning of “generate”.

Specifically, for example, when it is confirmed that the user's product (object) is “tissue paper” via a current situation check sheet, and an approach is “disruptive”, in the information processing apparatus (specifically, for example, the information processing apparatus 1 that will be described later and that is illustrated in FIG. 11), a question of “What is the common sense of the commodity itself?” that corresponds to “disruptive” in the table illustrated in FIG. 3 is extracted, and a question of “What is the common sense of tissue paper?” is generated based on the question.

Furthermore, for example, even if details of the user information separately acquired are not enough, and if it is not possible to identify the product that the user is manufacturing, in the information processing apparatus (specifically, for example, the information processing apparatus 1 that will be described later and that is illustrated in FIG. 11), it is assumed herein that a determination result, which is acquired via the current situation check sheet, that a detail of “innovation” that the user desires corresponds to the “product that the user is manufacturing” is outputted. Even in this case, as long as the “approach” is “disruptive” as described above, in the information processing apparatus (specifically, for example, the information processing apparatus 1 that will be described later and that is illustrated in FIG. 11), the question of “What is the common sense of the commodity itself?” that corresponds to “disruptive” in the table illustrated in FIG. 3 is extracted. However, in this example, unlike “tissue paper” described above, since it is only possible to identify abstract information such as a “product that the user is manufacturing” in the information processing apparatus (specifically, for example, the information processing apparatus 1 that will be described later and that is illustrated in FIG. 11), no target is intentionally identified, but a question of “What is the common sense of the commodity itself?” is simply generated based on the extracted questions.

Furthermore, for example, although on the premise of product innovation in the business field as a type of innovation, there may be a question of “What is your company's technological strength?” that corresponds to an approach of “diversion”. This is, although it is a type of innovation on the premise of the product in the business field of the user, a question that enables innovation to be diverted to fields other than the business field of the user by performing “shifting” using a “device” of “addition”, described later, based on the premise of the question “What is your company's technological strength?”. Specifically, for example, it is assumed herein that the business field of the user is manufacturing and selling chemical films. It is also assumed herein that the reply by the user to the question of “What is your company's technological strength?” is “nano-chemistry”. As will be described later in detail, adding (applying) such a reply as described above to other fields makes it possible to acquire a result of innovation diverted to fields other than the business field of the user. That is, it is possible to apply the technology pertaining to the present service to innovation in fields other than the business field of the user.

Note herein that a user having no such information that leads to a hint may face difficulties in uniquely imaging a detail of innovation. Therefore, even if an abstract question (hereinafter referred to as an “open question”) from which it may lead to replies with wide variety of details is presented to users, most of the users may not be certain in how to reply it, i.e., may face difficulties in replying it. Therefore, in the present service, for example, such a question is presented that, similar to the example question described above (a question pertaining to tissue paper), although it is formally an open question, has an aspect that is similar to a specific question (hereinafter referred to as a “closed question”) that substantially requires a limiting reply only. That is, a question presented to the user is set to have a detail that aims to extract specific and other facts from the user to visualize problems that have not yet been visualized. Therefore, questions presented to the user through the present service facilitate the user to easily reply to them.

Questions extracted or generated through the process described above are, as illustrated in step SS4 in FIG. 1, displayed on the information processing apparatus (for example, the information processing apparatus 1 illustrated in FIG. 11) and presented to the user. Then, when the user manipulates the information processing apparatus to input sentences (hereinafter referred to as “reply sentences”) to reply to the questions, input information about them is acquired.

Then, as illustrated in step SS6 in FIG. 1, keywords are extracted based on the reply sentences. Then, as illustrated in step SS7 in FIG. 1, the keywords are mechanically shifted (converted) using a predetermined device.

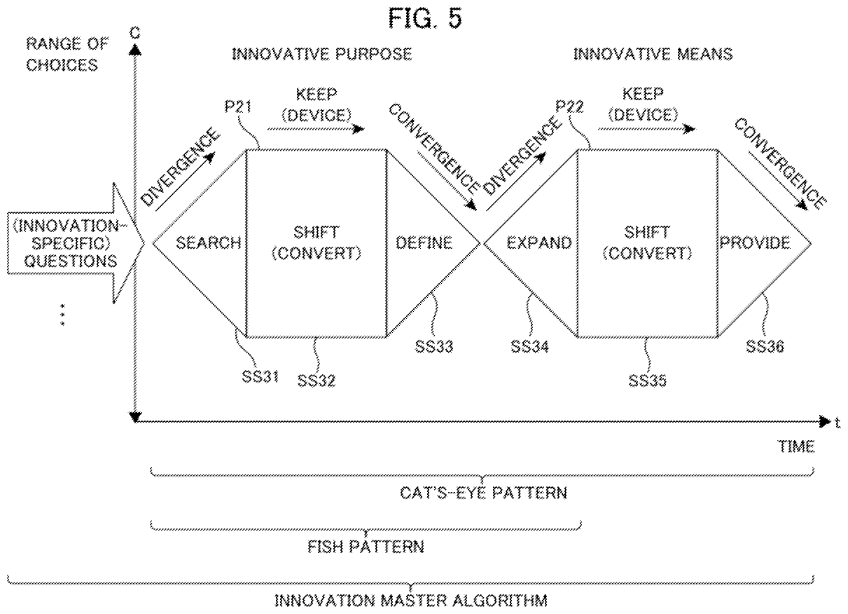

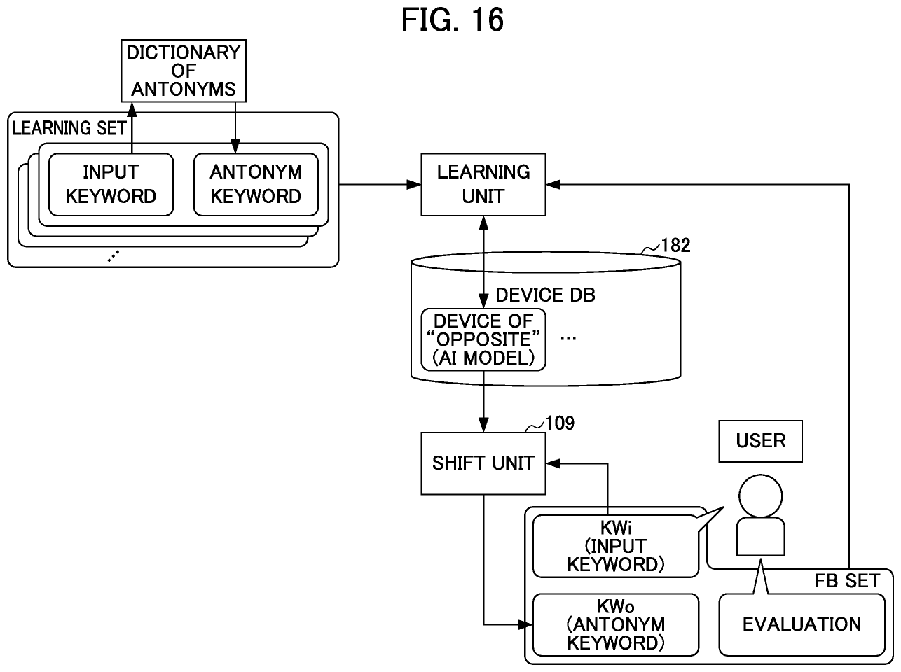

Specifically, in the present service, as a method of proposing a detail that the user may recognize as “innovation”, a method of using an “intangible keyword” is adopted. An “intangible keyword” refers to another keyword acquired as a result of using a predetermined device to mechanically make a shift (a conversion) on one or more keywords included in reply sentences to questions. The term “device” used herein refers to a converter that uses a predetermined conversion method to shift (convert) a keyword included in a reply sentence into an “intangible keyword”. There are a plurality of types of devices that are stored beforehand and managed in a predetermined device (for example, a device DB 182 that will be described later and that is illustrated in FIG. 11). Note that a method of converting a device is not particularly limited. For example, it is possible to adopt such devices as “opposite”, “addition and subtraction”, “equivalent”, and “cause and effect”. Among them, the device of “opposite” is a device that shifts (converts) a keyword included in a reply sentence into an “intangible keyword” having an opposite meaning. The devices of “addition and subtraction” are devices that add a predetermined element to a keyword included in a reply sentence to shift (convert) it into an “intangible keyword” and that subtract a predetermined element from a keyword included in a reply sentence to shift (convert) it into an “intangible keyword”. The device of “equivalent” is a device that shifts (converts) a keyword included in a reply sentence into an “intangible keyword” having a meaning of an equivalent or higher concept. Furthermore, a specific example of generating or updating a device will be described later with reference to FIGS. 16 to 19. Furthermore, as will be described later in detail, a device used in step SS35 illustrated in FIG. 5 converts each of the one or more sentences acquired in a previous stage, i.e., in step SS34 into each of one or more sentences illustrated in a later stage, i.e., in step SS36. That is, a device will be hereinafter referred to as one that, when one or more keywords or one or more sentences is or are inputted, outputs one or more keywords or one or more sentences converted through a predetermined conversion method.

In the present service, one or more devices that should be used for shifting (converting) is or are selected based on a detail of an “approach” that is to be set. Specifically, for example, since, in this example and in the table illustrated in FIG. 3, the “approaches”, the “questions”, and the devices are associated with each other beforehand, a device is selected based on the table (the correspondence relation) illustrated in FIG. 3. For example, when an “approach” is “disruptive”, “opposite” is selected as a device that should be used for shifting (converting). For example, it is assumed herein that a question of “What is the common sense of tissue?” is generated for the “approach” described above, and a reply sentence by the user to this question includes keywords of “white”, “colorless”, “each piece is pulled up from above”, “rectangular”, and “contained in a box”. In this case, when “opposite” is selected as a device, a keyword of “white”, for example, is shifted (converted) into “black” representing an “intangible keyword” having an opposite meaning. Furthermore, similarly, the keywords of “colorless”, “each piece is pulled up from above”, “rectangular”, and “contained in a box” are respectively shifted (converted) into “intangible keywords” of “colored”, “push up from beneath”, “circular”, and “not contained in a box”.

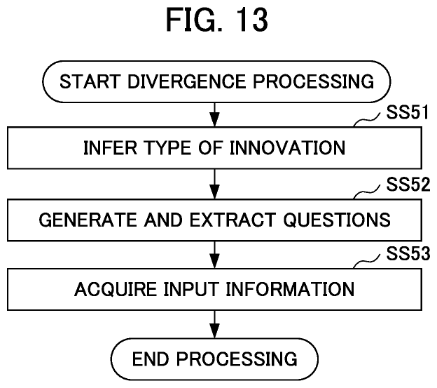

As described above, shifting (converting) using a device is mechanically performed. Note herein that, the term “mechanically performed” means that it is performed without requiring a manipulation in accordance with an intention of the user, i.e., it is automatically performed independently from an intention of the user. That is, a device mechanically performs shifting (converting) in accordance with a predetermined conversion formula (see FIG. 13 and other drawings described later) without being restricted by social or individual common sense (user's common sense). Note that the expression “mechanically perform shifting in accordance with predetermined conversion formula” used herein is not particularly limited to performing computation based on the predetermined conversion formula in a real time manner, but falls within the scope of a broad concept, for example, that includes automatic outputting by a model (a device) generated through machine learning using learning data created in accordance with a predetermined conversion formula, as will be described later. Therefore, an “intangible keyword” generated as a result of shifting (converting) may have a detail that is outside a range of the common sense in the society for the user. As described above, it is possible to utilize an “intangible keyword” that is outside the range of the social or individual common sense for the user as a hint for creating “innovation”. However, even when the user acquires a mere row of “intangible keywords” acquired as a result of shifting (converting) using a device in this way, the user may face difficulties in creating a detail of “innovation” based on it. Therefore, in the present service, scoring of an “intangible keyword” is further performed.

That is, in the present service, as illustrated in step SS8 in FIG. 1, when a plurality of keywords included in a reply sentence are shifted (converted) into a plurality of “intangible keywords”, scoring is performed from various points of view for each of the plurality of “intangible keywords”. Specifically, for example, scoring is performed from points of view of innovativeness, cost effectiveness, feasibility, and profitability.

It is assumed herein that a meaning of “innovation” for the user is to develop a new product of tissue paper representing product (object), and scoring of an “intangible keyword” is performed from the point of view of “innovativeness”. In this case, scoring of an “intangible keyword” of “black” acquired as a result of shifting of a keyword pertaining to a fact that tissue is “white” is performed using such a method as described below, for example. That is, keyword retrieval is performed for “black tissue paper” in a search and retrieval site available on the Internet and its innovativeness is evaluated based on its hit count and appropriateness of the details of a result of the retrieval. Then, a result of the evaluation is indicated as a score.

Furthermore, for example, it is assumed herein that scoring of the “intangible keyword” is performed from the point of view of “cost effectiveness”. In this case, scoring of the “intangible keyword” of “black” is performed using a method as described below, for example. That is, a cost that may occur when actually manufacturing black tissue paper is trial-calculated, and its cost effectiveness is evaluated based on a result of the trial calculation. Specifically, for example, it is assumed herein that, when black tissue paper is to be manufactured, it is possible to realize it by increasing types of inks to be used with neither changing a conventional manufacturing line nor adding another manufacturing line. In this case, it is evaluated that it is possible to realize it at a lower cost, resulting in a higher score.

Furthermore, it is possible to allow a direct evaluation by the user to be reflected in scoring of an “intangible keyword”. For example, it is assumed herein that scoring of the “intangible keyword” is performed from the point of view of “profitability”. In this case, scoring of the “intangible keyword” of “black” results in a higher score when the user finds its value in the color of a sound of “black”.

After scoring of the “intangible keyword” is performed, a “tangible sentence” is generated based on the one or more “intangible keywords” respectively having undergone the scoring. A “tangible sentence” refers to a sentence that is generated when one or more “intangible keywords” is or are joined through a predetermined method and some adjustments are made. Such a step as described above will be hereinafter referred to as “contextualization”. Note that a method used when joining one or more “intangible keywords” is not particularly limited, and, for example, it is possible to adopt such a method of joining essential points of keywords (essential point joining method). Furthermore, for example, it is possible to adopt such a method that uses a technology of text mining (hereinafter referred to as “text mining” in an abbreviated manner). That is, as an example of text mining, such technologies that predetermined keywords and predetermined clauses are gathered into a sentence and a sentence is summarized into a shorter sentence are realized based on artificial intelligence (AI). Therefore, when one or more “intangible keywords” is or are inputted into such AI as described above, a sentence joined by the AI is outputted. With the predetermined essential point joining method and text mining described above, and through contextualization of “intangible keywords” such as “black” and “not contained in a box” pertaining to “tissue paper” representing product (object), a “tangible sentence” of “black tissue paper that is not contained in a box”, for example, is generated. Note that, in the present service, contextualization of “intangible keywords” to generate a “tangible sentence” is not always necessary.

After a “tangible sentence” is generated, “embodying” of a “tangible sentence” or “intangible keywords” is performed. The term “embodying” refers to generating a specific example when a “tangible sentence” and “intangible keywords” are applied to a business model in a predetermined field (an industry's commodity). One that has undergone “embodying” as a business model will be hereinafter referred to as a “tangible answer”. Specifically, for example, it is assumed herein that a “tangible sentence” of “black tissue paper that is not contained in a box” is generated. In this case, a specific example when “black tissue paper that is not contained in a box” is applied to a business model in the field of tissue paper products is generated as a “tangible answer”. Note that, even in generating a “tangible answer”, it is also possible to use the essential point joining method and text mining described above.

In the present service, a detail of “innovation” in the business field of the user (the industry's commodity) is generated based on at least one of the “intangible keywords”, the “tangible sentence”, and the “tangible answer”. It is possible to generate this detail of “innovation” as a sentence by adopting the predetermined essential point joining method and text mining described above, for example. Then, the generated detail of “innovation” is proposed to the user.

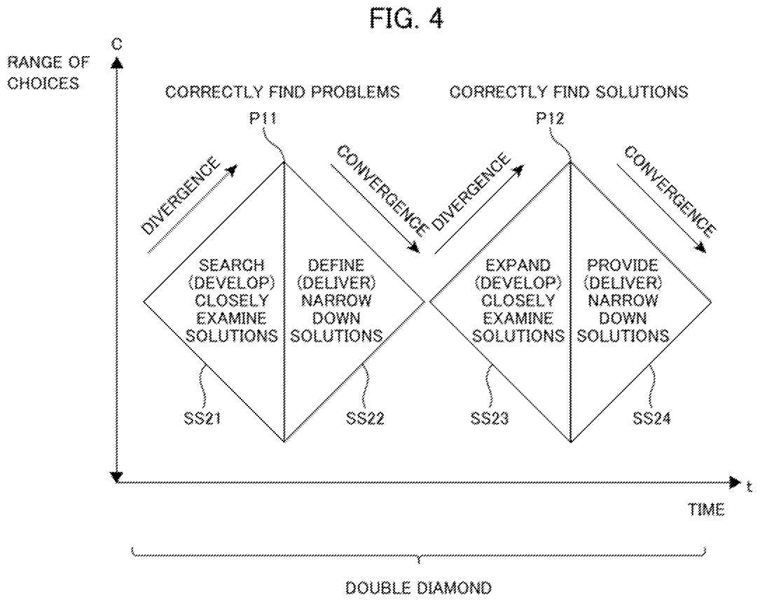

Next, a process of generating a detail of “innovation” will be described with reference to FIGS. 4 and 5. FIG. 4 is a graph visualizing a creation process of a detail of “innovation” using a conventional method. The graph illustrated in FIG. 4 is referred to as a double diamond, since two rhombic shapes (diamond shapes) are joined to each other.

In the graph illustrated in FIG. 4, the creation process of a detail of “innovation” using the conventional method is indicated by a relation of time t (a horizontal axis) and range of choices c (a vertical axis). Note that a range of choices c at a certain time tin FIG. 4 indicates that the longer the length in a longitudinal direction, the wider the range of choices c at that point in time. The conventional creation process of a detail of “innovation” has been achieved by a step of “correctly finding problems” that should be solved and a step of “correctly finding solutions” for solving the problems.

Specifically, by having undergone processes from step SS21 to step SS24 illustrated in FIG. 4, a detail of “innovation” is generated. That is, in a stage (step SS21) of “Search (Discover)” for closely examining problems, such a method as so-called brain-storming diverges choices (expands choices c). At this time, the range of choices c arrives at a first peak P11. Next, in a stage (step SS22) of “Definition (Define)” for narrowing down the closely-examined problems, the choices converge (the range of choices c narrows). In this way, it is possible to “correctly find problems” that should be solved. Next, in a stage (step SS23) of “Expand (Develop)” for closely examining solutions to the problems that are found, such a method as brain-storming also diverges choices (expands the range of choices c). At this time, the range of choices c arrives at a second peak P12. Finally, in a stage (step SS24) of “Provide (Deliver)” for narrowing down the closely examined solutions, the choices converge (the range of choices c narrows). In this way, it is possible to “correctly find solutions” for solving the problems that are found.

As described above, when the conventional method illustrated in FIG. 4 is used to create a detail of “innovation”, the range of choices c arrives at instantaneous peaks (the peaks P11 and P12) at a timing of transition from step SS21 to step SS22 and a timing of transition from step SS23 to step SS24.

FIG. 5 is a graph visualizing a creation process of a detail of “innovation” using the present service.

In the graph illustrated in FIG. 5, the creation process of a detail of “innovation” using the present service is indicated by a relation between time t (a horizontal axis) and range of choices c (a vertical axis). Note that a range of choices c at a certain time tin FIG. 5 indicates that the longer the length in a longitudinal direction, the wider the range of choices c at that point in time. Furthermore, the range of choices c in the graph illustrated in FIG. 5 means numbers of keywords included in a reply sentence, “intangible keywords”, and “tangible sentences”, for example. Creating a detail of “innovation” using the present service is achieved by, similar to the conventional method illustrated in FIG. 2, a step of finding “innovative purposes” that should be solved and a step of finding “innovative means” for solving the problems. That is, in the present service, by starting from an (innovation-specific) “question” and having undergone steps SS31 to SS36 described later, it is possible to find “innovative purposes” that should be solved and it is also possible to find “innovative means”.

Note that, in the present embodiment, as described above, it is clarified that what kind of a thing is the user recognizing as “innovation” and what kinds of a type and a detail of “innovation” does the user desire, and then an (innovation-specific) “question” based on an “approach” is presented to the user. That is, based on a reply to such a question as described above, a stage (step SS31) of “Search (Discover)” for closely examining problems, which will be described later and which is illustrated in FIG. 5, is performed. As described above, since a detail of “innovation” is created after a “question” based on an “approach” is presented and the processes from steps SS31 to SS36 illustrated in FIG. 5 are performed, it is possible to refer to it as an “innovation master algorithm”.

Specifically, in the present service, by having undergone the processes from step SS31 to step SS36 illustrated in FIG. 5, a detail of “innovation” is created. That is, in a stage (step SS31) of “Search (Discover)” for closely examining problems, keywords included in a reply sentence to the question (the range of choices c) diverges (expands) in number. Note herein that, although the range of choices c (the number of keywords included in the reply sentence) arrives at a peak P21, the peak P21 illustrated in FIG. 5, which is not an instantaneous one, is kept for a certain period of time, differently from the peak P11 illustrated in FIG. 2. One reason of this is that, in the present service, a plurality of keywords included in a reply sentence (which correspond to the range c in number) are shifted (converted) into a plurality of “intangible keywords” (which correspond to the range c in number) using a predetermined device at a timing of arrival at the peak P21 (step SS32). Upon completion of the shifting (converting), the processing proceeds to a stage (step SS33) of “Definition (Define)” for narrowing down the plurality of “intangible keywords” that are generated as a result of the shifting (converting). In step SS33, a step of contextualizing the “intangible keywords” into “tangible sentences” is performed. Thereby, the range of choices c converges (narrows) by a number of the “tangible sentences”. In this way, it is possible to “find innovative purposes” that should be solved.

Next, in a stage (step SS34) of “Expand (Develop)” for closely examining solutions to the problems that are found, some embodying methods (production means) are enumerated for innovative keywords selected from the “tangible sentences”, for example, to diverge choices. Note herein that, although the range of choices c arrives at a peak P22, shifting (converting) is performed (step SS35), and a state of the peak is kept for a certain period of time, similarly to the peak P21. Finally, in a stage (step SS36) of “Provide (Deliver)” for narrowing down the closely examined solutions, a step of “embodying”, which is described above, is performed, and a “tangible answer” is acquired. Thereby, the range of choices c converges by a number of “tangible answers”. In this way, it is possible to “find innovative means” for solving purposes that are found. That is, a “tangible answer” is generated. As described above, when the present service is used to create a detail of “innovation”, the range of choices c arrives at continuous peaks (the peaks P21 and P22) while shifting (converting) is performed in step SS32 and step SS35 respectively.

Specifically, for example, it is assumed herein that such a “tangible sentence” of “black tissue paper that is not contained in a box” illustrated in the example described above is generated. Then, it is assumed herein that black tissue paper is selected as an innovative term from this “tangible sentence”. In this case, in step SS34, means of producing black tissue paper diffuses. For example, it is assumed herein that, as some means that are enumerated, there are means of utilizing a new, expensive material and of using black ink at a large amount. In step SS35, shifting (converting) is performed for each of the some means of producing black tissue paper using a predetermined device. Then, in step SS36, a “tangible answer” is acquired. For example, it is assumed herein that the device of “subtraction” in addition and subtraction is adopted as a predetermined device, “utilize a new, expensive material” is converted into “utilize an inexpensive waste material”, and “use black ink at a large amount” is converted into “use black ink at a small amount”. In this case, when black tissue paper is to be produced with a method of utilizing an inexpensive waste material and, after that, of using ink at a small amount, it is possible to provide inexpensive black tissue paper. That is, such a “tangible answer” is acquired as product innovation.

Note that it is possible to refer to two hexagonal shapes that correspond to steps SS31 to SS36 described above in the graph illustrated in FIG. 5 as a “cat's-eye pattern” when seeing the shape as the eyes of a cat. By using such a “cat's-eye pattern” as described above, a “tangible answer” is created.

Furthermore, it is possible to refer to one hexagonal shape and one triangular shape, which correspond to steps SS31 to SS34 described above in the graph illustrated in FIG. 5, as a “fish pattern” when seeing the shape as a fish. By using such a “fish pattern” as described above, an “embodying method (a production means)” is created. Note herein that the user having certain perceptiveness and recognizing those up to the created “embodying method (the production means)” is able to recognize what kinds of means that the user is able to actually take in the future. That is, in a case of the example described above, the user recognizing some means of producing black tissue paper is able to recognize what kind of a means that the user is able to actually take in the future. That is, when the user having certain perceptiveness is provided with those up to a fish pattern, it is possible to achieve a support for creating innovation.

Note that it is needless to say that, for the user who desires to recognize an “innovative purpose”, using up to one hexagonal shape that corresponds to steps SS31 to SS33 described above in the graph illustrated in FIG. 5 makes it possible to achieve a support for creating innovation. On the other hand, for the user who is not satisfied in step SS36, the processes in steps SS34 to SS36, which correspond to a right side eye in the cat's-eye pattern, may be repeatedly executed a plurality of times.

Furthermore, the innovation creation process corresponding to steps SS31 to SS36 described above in the graph illustrated in FIG. 5 has been described as an example based on one (innovation-specific) “question”. However, it is possible to perform the innovation creation process corresponding to steps SS31 to SS36 described above in the graph illustrated in FIG. 5 based on a plurality of (innovation-specific) “questions”. That is, in FIG. 5, as indicated by “ . . . ” below an arrow indicating the (innovation-specific) “question”, when a plurality of “questions” are presented to the user, it is possible to acquire a plurality of “tangible answers” through the innovation creation process corresponding to steps SS31 to SS36 based on each of replies to the questions. Thereby, the user is able to select an “innovative means” that is deemed to be more appropriate from the plurality of “tangible answers”. Furthermore, for example, it is possible to create a more innovative means through the innovation creation process performed appropriately a plurality of times based on “tangible sentences” and “tangible answers”. That is, using a plurality of “questions” and having undergone the innovation creation process a plurality of times in a vertical axis direction illustrated in FIG. 5 makes it possible to achieve further development in a horizontal axis direction illustrated in FIG. 5. It is possible to refer to such expansion as described above as a “beehive pattern” when seeing the shape of the plurality of hexagonal shapes corresponding to steps SS31 to SS36 as a hive of bees.

The creation process of a detail of “innovation” in the present service has been described above with reference to FIG. 5. An example of applying the creation process of a detail of “innovation” in the present service to a detail other than “innovation”, i.e., a detail of “business” such as problem solving, branding, and marketing will now be described herein with reference to FIG. 6.

FIG. 6 is a graph visualizing a creation process of a detail of “business”, to which the creation process of a detail of “innovation” illustrated in FIG. 5 is applied.

In the graph illustrated in FIG. 6, the creation process of a detail of “business” in the present service is indicated by a relation between time t (a horizontal axis) and range of choices c (a vertical axis). Note that a range of choices c at a certain time tin FIG. 6 indicates that the longer the length in a longitudinal direction, the wider the range of choices c at that point in time. Furthermore, the range of choices c in the graph illustrated in FIG. 6 means numbers of keywords included in a reply sentence, “intangible keywords”, and “tangible sentences”, for example. Creating a detail of “business” using the present service is achieved by, similar to the conventional method illustrated in FIG. 5, a step of finding “business purposes” that should be solved and a step of finding “business means” for solving the problems. That is, by applying the creation process of a detail of “innovation” illustrated in FIG. 5, starting from a (non-innovation-specific) “question”, and having undergone steps SS31 to SS36, basically similar to those described with reference to FIG. 5, it is possible to find “business purposes” that should be solved and it is also possible to find “business means”.

That is, different from the example of the present service described with reference to FIG. 5, and it is not limited to “innovation”, “business” that the user desires may be clarified, and “questions” pertaining to the predetermined business based on an “approach” may be presented to the user. That is, instead of the (innovation-specific) “question” as described above, (non-innovation-specific) “questions”, i.e., (business-specific, such as problem solving, branding, and marketing) “questions” may be presented. In this case, since a detail of “business” is created by similarly having undergone the processes from steps SS31 to SS36 illustrated in FIG. 5, it is possible to refer to it as a “business master algorithm”.

Note herein that the example of the innovation creation process pertaining to tissue paper described above will be summarized below. In this example, the cat's-eye pattern (the pattern where the hexagonal shape is repeated twice) used in steps SS31 to SS36 illustrated in FIG. 5 is adopted.

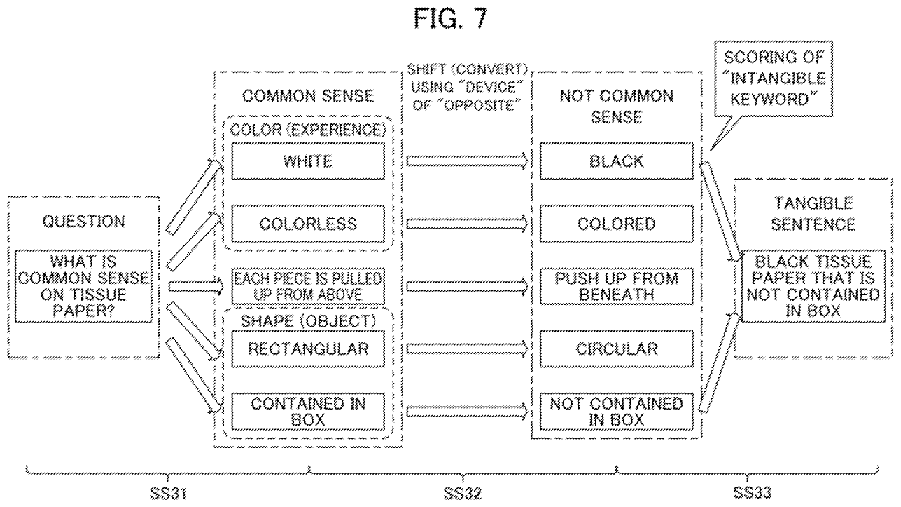

Processes in steps SS31 to SS33 illustrated in FIG. 5, which correspond to a left side eye (the previous stage) in a cat's-eye pattern, will first be described with reference to FIG. 7. FIG. 7 is a diagram illustrating a specific example indicating the processes in steps SS31 to SS33 in the innovation creation process illustrated in FIG. 5.

As illustrated in FIG. 7, a “question” of “What is the common sense of tissue paper?” is presented to the user in step SS31. Specifically, for example, as described above, when one of “approaches” is “tissue paper representing product (object)”, a question of “What is the common sense of the commodity (tissue paper here)?” is extracted. Then, the (innovation-specific) “question” based on the “approach” is presented to the user.

Next, as illustrated in FIG. 7, based on reply sentences by the user to the presented question, keywords of “white”, “colorless”, “each piece is pulled up from above”, “rectangular”, and “contained in a box” are extracted as pieces of the common sense of tissue paper. That is, keywords of “white”, “colorless”, “each piece is pulled up from above”, “rectangular”, and “contained in a box” included in the reply sentences by the user to the “question” of “What is the common sense of tissue” described above are extracted.

Next, as illustrated in FIG. 7, in step SS32, shifting (converting) using a “device” of “opposite” is executed. That is, in the case described above, when “opposite” is selected as a device, the keyword of “white”, for example, is shifted (converted) into “black” representing an “intangible keyword” having an opposite meaning. Furthermore, similarly, the keywords of “colorless (white)”, “each piece is pulled up from above”, “rectangular”, and “contained in a box” are respectively shifted (converted) into “intangible keywords” of “colored (black)”, “push up from beneath”, “circular”, and “not contained in a box”. As described above, the “device” of “opposite” is used to shift (convert) keywords serving as pieces of the “common sense”, which are included in the reply sentences, into keywords that are deemed to be “lack of common sense”.

Next, as illustrated in FIG. 7, in step SS33, a “tangible sentence” is generated. Specifically, for example, scoring of each of the plurality of “intangible keywords” acquired as a result of the shifting (converting) in step SS32 is first performed from various points of view. That is, scoring of each of the “intangible keywords” of “colored (black)”, “push up from beneath”, “circular”, and “not contained in a box” is performed from points of view of innovativeness, cost effectiveness, feasibility, and profitability. Then, after scoring of the “intangible keywords” is performed, a “tangible sentence” is generated based on the one or more “intangible keywords” respectively having undergone the scoring. That is, for example, based on the “intangible keywords” of “colored (black)” and “not contained in a box”, a “tangible sentence” of “black tissue paper that is not contained in a box” is generated.

By summarizing those described above, what are performed in steps SS31 to SS33 for finding innovative purposes in the present service are: (1) presenting of questions to the user and retrieving their replies, (2) shifting (converting) of keywords included in the replies into “intangible keywords”, (3) scoring of the “intangible keywords”, and (4) generating of a “tangible sentence” through contextualization of the “intangible keywords”. An important point here is, as preliminary processing to (1), clarifying what kind of a thing is the user recognizing as “innovation” and what kind of a detail of “innovation” does the user desire. Thereby, it is possible to prevent such a detail of innovation that the user does not intend, which may happen due to ambiguity in the term “innovation”, from being provided. Furthermore, even if the user does not know at all how to generate “innovation”, only (1) is performed within the scope of the user's common sense (within the scope of user's imagination), then automatically (2) to (4) are performed. As a result, it is possible to propose a detail of “innovation” to the user. Here, (1) and/or (3) is or are performed by taking into account a result of the preliminary processing. As a result, a detail of “innovation” proposed to the user may satisfy what the user desires. Therefore, it is possible to increase the user's degree of satisfaction.

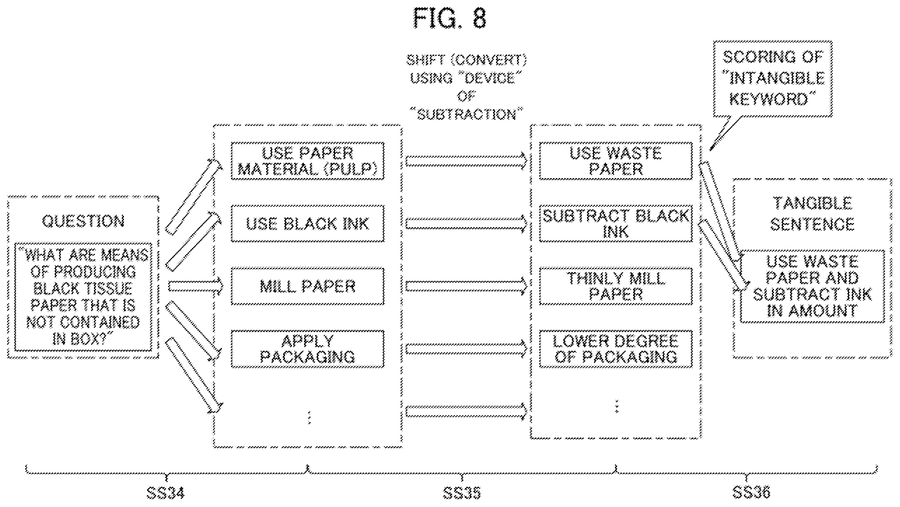

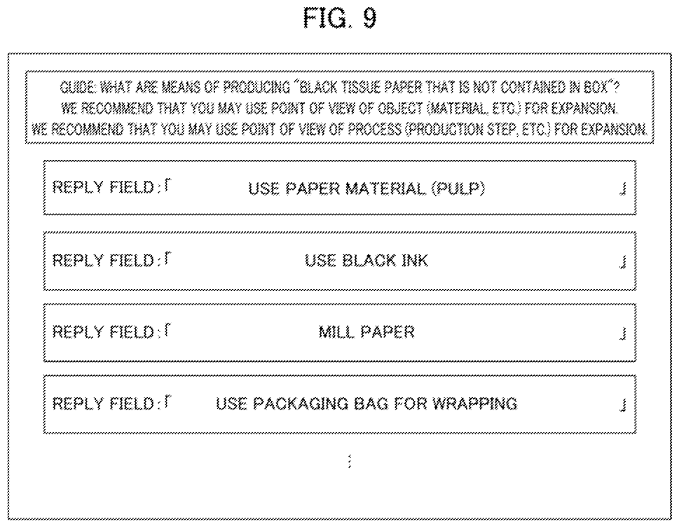

The processes in steps SS31 to SS33, which corresponds to the left side eye in the cat's-eye pattern illustrated in FIG. 5, has been described above with reference to FIG. 7. Next, processes in steps SS34 to SS36, which correspond to the right side eye, will be described with reference to FIGS. 8 and 9. FIG. 8 is a diagram illustrating a specific example indicating the processes in steps SS34 to SS36 in the innovation creation process illustrated in FIG. 5. FIG. 9 is a diagram illustrating an example of an interface presented to the user in a stage (step SS34) of diffusing innovative means illustrated in FIG. 7. As illustrated in FIG. 8, in step SS34, a “question” of “What are means necessary for producing black tissue paper that is not contained in a box?” is first presented to the user. Specifically, for example, the interface illustrated in FIG. 9 is presented to the user. On the interface illustrated in FIG. 9, such a question of “Please tell us means necessary for producing black tissue paper that is not contained in a box as much as possible.” is displayed. Furthermore, on the interface illustrated in FIG. 9, guides of “We recommend that you may use a point of view of object (material, etc.) for expansion.” and “We recommend that you may use a point of view of process (production step, etc.) for expansion.” are displayed. As described above, in the present service, a question for embodying innovation to the user is set. Then, the user is able to input reply sentences to the question. Specifically, for example, on the interface illustrated in FIG. 9, a plurality of reply fields are prepared. Then, in the example illustrated in FIG. 9, the user has inputted replies of “use a paper material (pulp)”, “use black ink”, “mill paper”, and “apply packaging”. As described above, in the present service, it is possible to further display guides to the user, allowing a question to become a closed question or an open question that is more similar to a closed question. Thereby, the user is able to more easily reply to the question. As a result, as illustrated in FIG. 8, diffusion occurs from the question.

Next, as illustrated in FIG. 8, in step SS35, shifting (converting) is performed using a “device” for the reply sentences by the user. In the shifting (converting) using a “device” in step SS35, each of reply sentences may be shifted (converted) using each “device” among a plurality of different “devices”. However, it is described herein that all the reply sentences in the example illustrated in FIG. 8 are shifted using the device of “subtraction” in “addition and subtraction”.

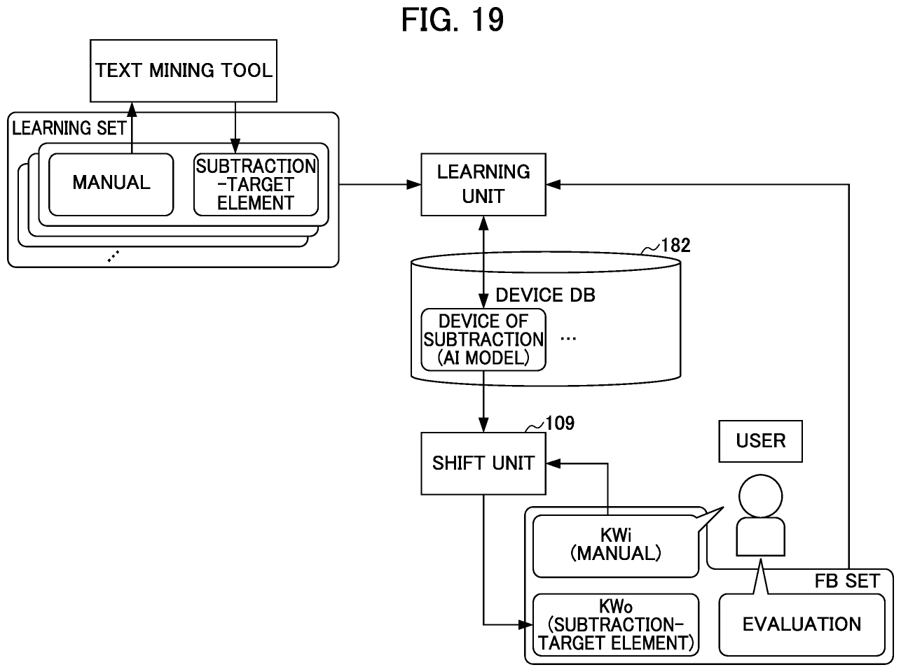

As illustrated in FIG. 8, when the device of “subtraction” in “addition and subtraction” is adopted as a “device”, the reply sentences described above are respectively shifted (converted) into such intangible keywords of “use waste paper”, “subtract black ink”, “thinly mill paper”, and “lower the degree of packaging”. That is, the “device” of “subtraction” in “addition and subtraction” is a “device” that is able to make “subtractions” in “material”, “cost”, “process”, “risk”, “personnel”, “effort”, “problem”, “time”, and “space”, for example. A method of generating the device of subtraction will be described later with reference to FIG. 19.

Note that the present service is able to not only automatically perform shifting (converting) using a “device” through the information processing, but also perform shifting (converting) using a “device” by the user by presenting a guide in accordance with the “device” to the user. Thereby, the user is able to learn a “method of embodying (a production means)” innovation.

Furthermore, the user is able to not only use the processes in steps SS31 to SS33 illustrated in FIG. 5 to derive innovative purposes, but also use the processes in steps SS34 to SS36 illustrated in FIG. 5 to derive innovative means. That is, it can be said that, after it is derived that what kind of innovation will be realized, it is derived that how the innovation will be realized. For example, even when a tangible sentence is derived through the processes in steps SS31 to SS33, the user may not able to satisfy the details. Furthermore, for example, the user may face difficulties in implementing its detail. Therefore, the processes in steps SS31 to SS36 allow the user to specifically study and derive an innovative means (how to realize innovation). At this time, in step SS34, the user replies a question for the means that is necessary for realizing the innovative purpose. That is, in this example, the user is a manufacturer of tissue paper. That is, the user is trying to create innovation to its product, i.e., tissue paper. Therefore, the specific method (means) of manufacturing tissue paper is understood at a certain level. Therefore, in usual cases, the user is able to properly reply to the question in step SS34. Then, when the replies by the user are shifted through the processing in step SS35 as described above, an innovative means is derived and recognized by the user as one that is possible to realize. Then, it is accepted by the user as one created by the user.

Furthermore, the effects that make it possible to specifically perform studying and deriving become significant when the processes in steps SS34 to SS36 are repeatedly performed. In the present service, after the processes as described above are performed, (5) generating of “tangible answers” through embodying of “intangible keywords” and “tangible sentences”, and (6) providing of the “tangible answers” to the user are performed. Thereby, to realize innovation, the user is presented with what kind of a means should the user take. However, the user having certain perceptiveness and recognizing those up to the created “tangible sentences” is able to recognize how to actually realize the “tangible sentences” in the future. That is, the user described above is able to feel that it is embodied even with such “tangible sentences”. However, other users may not feel that it not embodied even with such “tangible sentences”. Therefore, in the present service, by embodying “intangible keywords” and “tangible sentences” illustrated in FIG. 5 described above, generating of “tangible answers” and (6) providing of the “tangible answers” to the user are performed.

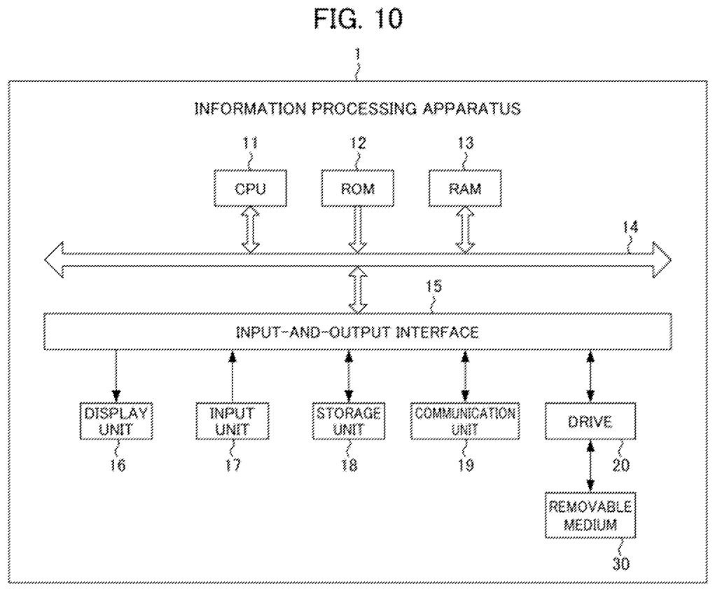

The information processing apparatus 1 that is subject to the application of the present service described above is able to have a hardware configuration as illustrated in FIG. 11, for example. FIG. 10 is a block diagram illustrating an example of the hardware configuration of the information processing apparatus according to the embodiment of the present invention.

The information processing apparatus 1 includes a central processing unit (CPU) 11, a read only memory (ROM) 12, a random access memory (RAM) 13, a bus 14, an input-and-output interface 15, a display unit 16, an input unit 17, a storage unit 18, a communication unit 19, and a drive 20.

The CPU 11 executes programs recorded in the ROM 12 or programs loaded from the storage unit 18 to the RAM 13, and, in accordance with the programs, executes various types of processing. The RAM 13 appropriately stores, for example, information necessary for the CPU 11 to execute various types of processing.

The CPU 11, the ROM 12, and the RAM 13 are coupled to each other via the bus 14. The bus 14 is further coupled to the input-and-output interface 15. The input-and-output interface 15 is coupled to the display unit 16, the input unit 17, the storage unit 18, the communication unit 19, and the drive 20.

The display unit 16 is formed of a liquid crystal display of any type, for example, to output various types of information. For example, in the present embodiment, various images pertaining to questions are displayed to the user. The input unit 17 is formed of a keyboard, for example, to accept various types of information. For example, in the present embodiment, the user inputs replies to the questions displayed on the display unit 16. The storage unit 18 is formed of a dynamic random access memory (DRAM), for example, to store various types of data. The communication unit 19 controls communications that take place with other devices (for example, a non-illustrated server) via a network including the Internet.

The drive 20 is provided as required. The drive 20 is appropriately attached with a removable medium 30 such as a magnetic disk, an optical disk, a magnetic optical disk, or a semiconductor memory. A program read from the removable medium 30 by the drive 20 is installed into the storage unit 18 as required. Furthermore, the removable medium 30 is able to store various types of information stored in the storage unit 18, similar to the storage unit 18.

FIG. 11 is a functional block diagram illustrating an example of a functional configuration pertaining to innovation creation support processing, among functional configurations of the information processing apparatus illustrated in FIG. 10. The innovation creation support processing refers to a series of processing executed when the present service described above is provided to the user.

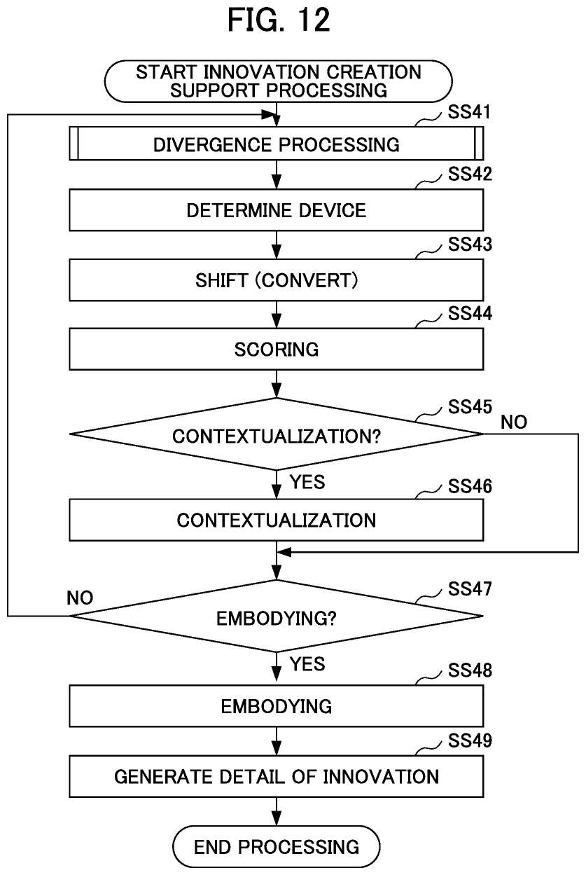

As illustrated in FIG. 12, in the CPU 11 of the information processing apparatus 1, such components function as an approach setting unit 101, a question generation unit 102, a device generation unit 114, a display control unit 103, an input receiving unit 104, an input information acquisition unit 105, a keyword extraction unit 106, an inference unit 107, a device determination unit 108, a shift unit 109, a scoring unit 110, a contextualization unit 111, an embodying unit 112, an innovation detail generation unit 113, and a device generation unit 114. Furthermore, in a region of the storage unit 18 of the information processing apparatus 1, a question database (DB) 181, a device DB 182, and a correspondence relation DB 183 are provided. Note that, in the example illustrated in FIG. 6, the question DB 181, the device DB 182, and the correspondence relation DB 183 are provided in the information processing apparatus 1. However, this configuration is a mere example. For example, the question DB 181, the device DB 182, and the correspondence relation DB 183 may be provided in another, non-illustrated information processing apparatus (for example, a server).

The approach setting unit 101 sets one or more “approaches” for questions to be presented to the user. Specifically, for example, the approach setting unit 101 sets “approaches” based on a result of inference (for example, a type of innovation that the user recognizes) by the inference unit 107 described later and the correspondence relation illustrated in the table in FIG. 2. Furthermore, the approach setting unit 101 is able to set any “approach” among the “approaches” based on details of replies to a current situation check sheet, among pieces of user information acquired by the input information acquisition unit 105 described later. That is, for example, as described above, “tissue paper” representing a type of innovation pertaining to “product” is set as a result of the inference by the inference unit 107. Then, when it is recognized that the user desires disruptive innovation based on the replies to the current situation check sheet, among the pieces of the user information, an “approach” of “disruptive” may be set, among those types of innovation pertaining to “product”.

The question generation unit 102 extracts or generates one or more questions that is or are appropriate for presenting to the user based on the one or more “approaches” that are set by the approach setting unit 101. The term generation used herein falls within the scope of a broad concept that includes not only generating of brand new questions, but also arranging of questions extracted from a plurality of questions prepared beforehand. In the present embodiment, the one or more questions generated by the question generation unit 102 is or are stored and managed in the question DB 181. Therefore, the question generation unit 102 is able to not only generate questions from scratch, but also extract and adopt appropriate questions from among questions stored in the question DB 181. Furthermore, in the present embodiment, information corresponding to the correspondence relation illustrated in the table in FIG. 2 is stored and managed in the correspondence relation DB. That is, in the question generation unit 102, a type of innovation is inferred as a result of inference by the inference unit 107 described later, and, based on the information corresponding to the correspondence relation stored in the correspondence relation DB 183, some questions stored in the question DB 181 are to be extracted.

The display control unit 103 executes control of causing the display unit 16 to display the one or more questions generated by the question generation unit 102. Thereby, the questions are presented to the user. Furthermore, the display control unit 103 executes control of causing the display unit 16 to display the detail of “innovation” generated by the innovation detail generation unit 113 described later. Thereby, the detail of “innovation” is provided to the user.

When reply sentences are inputted, the input receiving unit 104 receives them as input information. Furthermore, when user information is inputted, the input receiving unit 104 receives it as input information. Note herein that user information includes details of replies by the user to the current situation check sheet described above. Specifically, the input receiving unit 104 receives reply sentences and user information, which are inputted into the input unit 17 respectively as input information.

The input information acquisition unit 105 acquires the input information pertaining to the reply sentences and input information pertaining to the user information, which are received by the input receiving unit 104.

The keyword extraction unit 106 extracts one or more keywords included in the reply sentences acquired as the input information by the input information acquisition unit 105.

The inference unit 107 infers what kind of a thing is the user perceiving as “innovation” based on the details of the replies to the current situation check sheet, among the pieces of the user information acquired by the input information acquisition unit 105. That is, the inference unit 107 infers a type of innovation. Note that the inference unit 107 may also refer to information such as one or more keywords extracted by the keyword extraction unit 106 to increase accuracy of the inference. The inference unit 107 infers, based on a predetermined model, for example, what kind of a thing is the user perceiving as “innovation” based on the details of the replies to the current situation check sheet. Specifically, for example, a set (a data set) in which details of replies to current situation check sheets by other users and what kinds of things are the users perceiving as “innovation” are associated with each other is used as data for multiple learning, learning processing is performed, and then a model is generated or updated. The inference unit 107 uses such a model generated as described above to infer what kind of a thing is the user perceiving as “innovation”.

The device determination unit 108 determines a device used to shift (convert) one or more keywords extracted by the keyword extraction unit 106 respectively into “intangible keywords” based on a detail of the approach determined by the approach setting unit 101 and a result of the inference by the inference unit 107. Specifically, the device determination unit 108 selects and determines one or more devices from among a plurality of devices stored and managed in the device DB 182. Furthermore, in the present embodiment, the device determination unit 108 extracts one or more of the “devices” stored in the device DB 182 based on the information corresponding to the correspondence relation stored in the correspondence relation DB 183.

The shift unit 109 uses each of the one or more devices determined by the device determination unit 108 to shift (convert) each of the one or more keywords extracted by the keyword extraction unit 106 into each of one or more “intangible keywords” corresponding to each of the devices.

The scoring unit 110 performs scoring on each of the one or more “intangible keywords” outputted as a result of the shifting (converting) by the shift unit 109.

The contextualization unit 111 contextualizes the one or more “intangible keywords” outputted as a result of the shifting (converting) by the shift unit 109 to generate a “tangible sentence”. Specifically, the contextualization unit 111 takes into account a result of the scoring and other factors, joins the plurality of “intangible keywords” to each other, adds adjustments, performs contextualization, and generate a “tangible sentence”. As described above, it is possible to realize such contextualization by using a technology of text mining. That is, as an example of text mining, such technologies that predetermined keywords and predetermined clauses are gathered into a sentence and that a sentence is summarized into a shorter sentence are realized based on artificial intelligence (AI). Therefore, when one or more “intangible keywords” is or are inputted into such AI as described above, a sentence joined by the AI is outputted.

The embodying unit 112 generates a “tangible answer” that “embodies” at least either the one or more “intangible keywords” outputted as the result of the shifting (converting) by the shift unit 109 or the “tangible sentence” generated by the contextualization unit 111. Furthermore, the embodying unit 112 is also able to generate a ranking sheet in which “intangible keywords” are ranked based on each of scores of “intangible keywords” having undergone scoring by the scoring unit 110.

The innovation detail generation unit 113 generates a detail of innovation in the business field of the user (the industry's commodity) based on at least one of the one or more “intangible keywords” outputted as the result of the shifting (converting) by the shift unit 109, the “tangible sentence” generated by the contextualization unit 111, and the “tangible answer” generated by the embodying unit 112. The generated detail of innovation is displayed on the display unit 16. In this way, the detail of innovation is proposed to the user. Note that, in the above description, a case when a detail of innovation is generated through steps SS31 to SS33 illustrated in FIG. 6 has been described, for purposes of description. Note herein that, when a detail of innovation is generated using the cat's-eye pattern illustrated in FIG. 5 (or a pattern in which the right side eye is repeated), the functional blocks function in accordance with a flowchart illustrated in FIG. 13.

FIG. 12 is a flowchart illustrating the innovation creation support processing executed by the information processing apparatus having the functional configuration illustrated in FIG. 11.

Specifically, as the processes that correspond to the left side eye of the cat's-eyes and that are illustrated in steps SS31 to SS33 in FIG. 5, steps S41 to SS49 illustrated in FIG. 13 are executed.

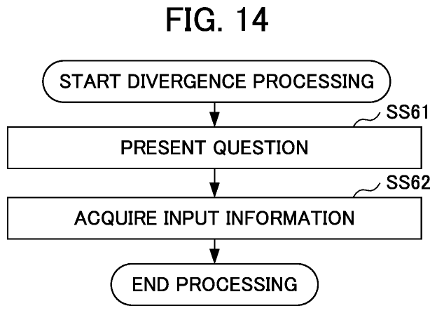

That is, in step SS41, divergence processing is performed. Note herein that, in the divergence processing that is performed as step SS31 in one of the processes that corresponds to the left side eye, the divergence processing illustrated in FIG. 14 is executed. FIG. 13 is a flowchart illustrating the divergence processing in one of the processes that correspond to the left side eye of the cat's-eyes illustrated in FIG. 5. That is, as illustrated in step SS51 in FIG. 13, a type of innovation is inferred. In step SS51 illustrated in FIG. 13, as the process in step SS31 illustrated in FIG. 5, the display control unit 103 first executes display control of first presenting a detail of a current situation check sheet to the user. Next, the input receiving unit 104 receives a document of replies by the user to the current situation check sheet. Next, the input information acquisition unit 105 acquires, as input information, user information including input information pertaining to the reply sentences received by the input receiving unit 104. Next, based on the details of the replies to the current situation check sheet among the pieces of the user information acquired by the input information acquisition unit 105, what kind of a thing is the user perceiving as “innovation” is inferred. Next, the inference unit 107 infers what kind of a thing is the user perceiving as “innovation” based on the details of the replies to the current situation check sheet among the pieces of the user information acquired by the input information acquisition unit 105.

Then, as illustrated in step SS52 in FIG. 13, questions are generated and extracted. That is, the approach setting unit 101 sets one or more “approaches” for questions to be presented to the user. Specifically, for example, the approach setting unit 101 sets “approaches” based on a result of the inference (for example, a type of innovation that the user recognizes) by the inference unit 107 described later and the correspondence relation illustrated in the table in FIG. 2. Next, the question generation unit 102 extracts or generates one or more questions that is or are appropriate for presenting to the user based on the one or more “approaches” that is or are set by the approach setting unit 101.

Then, as illustrated in step SS53 in FIG. 13, input information is acquired. That is, the display control unit 103 executes control of causing the display unit 16 to display the one or more questions generated by the question generation unit 102. Thereby, the questions are presented to the user. Next, when reply sentences are inputted, the input receiving unit 104 receives them as input information. Next, the input information acquisition unit 105 acquires the input information pertaining to the reply sentences and the input information pertaining to the user information, which are received by the input receiving unit 104. Next, the keyword extraction unit 106 extracts one or more keywords included in the reply sentences acquired as the input information by the input information acquisition unit 105. As described above, the divergence processing is executed.

As a result of the execution of the divergence processing illustrated in FIG. 14 as step SS41 illustrated in FIG. 13, the processing returns to FIG. 13, and steps SS42, SS43 illustrated in FIG. 13 are executed as step SS32 illustrated in FIG. 5. That is, as step SS32 illustrated in FIG. 5, in step SS42, the device determination unit 108 determines, based on the result of the inference by the inference unit 107 and the correspondence relation illustrated in the table in FIG. 2, a device used to shift (convert) each of the one or more keywords extracted by the keyword extraction unit 106 into an “intangible keyword”. Next, in step SS43, the device determination unit 108 determines, based on the detail of the approach determined by the approach setting unit 101, a device used to shift (convert) each of the one or more keywords extracted by the keyword extraction unit 106 into an “intangible keyword”. Specifically, the device determination unit 108 selects and determines one or more devices from among the devices stored and managed in the device DB 182. Then, in step SS44, the shift unit 109 uses each of the one or more devices determined by the device determination unit 108 to shift (convert) each of the one or more keywords extracted by the keyword extraction unit 106 into an “intangible keyword”.

In step SS44, the scoring unit 110 performs scoring on each of the “intangible keywords” outputted as a result of the shifting (converting) by the shift unit 109.

In step SS45, the contextualization unit 111 determines whether contextualization is necessary or not. When contextualization is not necessary, NO is determined in step SS45 and the processing proceeds to step SS46. Note that processing in and after step SS46 will be described later. On the other hand, when contextualization is necessary, YES is determined in step SS45 and the processing skips step SS46 but proceeds to step SS47. Note that the logic of determining whether contextualization is necessary or not is not particularly limited. For example, under an idea of a non-illustrated system designer or service provider, and based on a business field of a user (an industry's commodity), an approach, and other factors, whether contextualization is necessary or not may be determined.

Then, in step SS47, whether or not embodying is performed is determined. That is, for example, based on what a provider of the present service (a person having the knowledge about innovation), an AI model, or a user desires, whether or not embodying is performed is determined.

A case when the right side eye in the cat's-eye pattern, which includes the processes in steps SS34 to SS36 illustrated in FIG. 5, which is described with reference to FIGS. 8 and 9 above, is repeated will first be described. When the right side eye in the cat's-eye pattern, which includes the processes in steps SS34 to SS36 illustrated in FIG. 5, is repeated, NO is determined in step SS47 and the processing returns to step SS41. That is, as the processes that correspond to the right side eye in the cat's-eye pattern, steps SS41 to SS49 illustrated in FIG. 12 are executed. Note that a case when YES is determined in step SS47 will be described later.

FIG. 14 is a flowchart illustrating divergence processing in one of the processes that correspond to the right side eye of the cat's-eyes illustrated in FIG. 5 in the divergence processing illustrated in FIG. 12. Note herein that, in the divergence processing as the one of the processes that correspond to the right side eye in the cat's-eye pattern in step SS34, the divergence processing illustrated in FIG. 14 is executed. That is, in step SS51 illustrated in FIG. 14, as the process in step SS31 illustrated in FIG. 5, the display control unit 103 first executes display control of presenting the interface illustrated in FIG. 9 described above to the user. Specifically, for example, the display control unit 103 causes a “question” of “What are means necessary for producing black tissue paper that is not contained in a box?” to be presented to the user. Furthermore, for example, control of displaying a question of “Please tell us means necessary for producing black tissue paper that is not contained in a box as much as possible.” is executed. Furthermore, the display control unit 103 executes control of displaying guides such as “We recommend that you may use a point of view of object (material, etc.) for expansion.” and “We recommend that you may use a point of view of process (production step, etc.) for expansion.”.

Then, as illustrated in step SS62 in FIG. 14, input information is acquired. Next, when reply sentences are inputted, the input receiving unit 104 receives them as input information. Next, the input information acquisition unit 105 acquires the input information pertaining to the reply sentences and the input information pertaining to the user information, which are received by the input receiving unit 104. Next, the keyword extraction unit 106 extracts one or more keywords included in the reply sentences acquired as the input information by the input information acquisition unit 105. Note that, although, in the example illustrated in FIGS. 8 and 9 described above, a reply sentence from the user is shifted (converted) as is using a “device”, the keyword extraction unit 106 may appropriately extract one or more keywords included in a reply sentence acquired as input information by the input information acquisition unit 105. As described above, the divergence processing is executed.

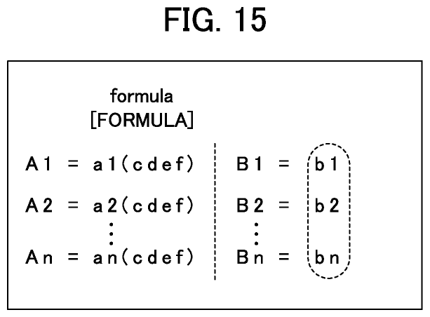

As a result of the execution of the divergence processing illustrated in FIG. 15 as step SS41 illustrated in FIG. 13, the processing returns to FIG. 13, and steps SS42, SS43 illustrated in FIG. 13 are executed as step SS35 illustrated in FIG. 5. That is, as step SS35 illustrated in FIG. 5, in step SS42, the device determination unit 108 determines, based on the result of the inference by the inference unit 107 and the correspondence relation illustrated in the table in FIG. 2, a device used to shift (convert) each of the one or more keywords extracted by the keyword extraction unit 106 into an “intangible keyword”. Next, in step SS43, the device determination unit 108 determines, based on the detail of the approach determined by the approach setting unit 101, a device used to shift (convert) each of the one or more keywords extracted by the keyword extraction unit 106 into an “intangible keyword”. Specifically, the device determination unit 108 selects and determines one or more devices from among the devices stored and managed in the device DB 182. Then, in step SS44, the shift unit 109 uses each of the one or more devices determined by the device determination unit 108 to shift (convert) each of the one or more keywords extracted by the keyword extraction unit 106 into an “intangible keyword”. At this time, devices that are respectively used to shift (convert) a plurality of reply sentences may differ from each other. Then, similar to steps SS45 and SS46 described above, contextualization is performed as required.

For example, if the user does not satisfy the result of the contextualization through the processing in step SS46, NO is determined in step SS47, and the processing returns to step SS41 in a repeated manner to repeat the right side eye in the cat's-eye pattern. Furthermore, for example, when the user satisfies the result of the contextualization through the processing in step SS46, YES is determined in step SS47, the processing proceeds to steps SS48 and SS49, and innovation is embodied.

It is assumed that YES is determined in step SS47 to continue the description. A case when NO is determined in step SS47 will be described later.

That is, in this case, steps SS48 and SS49 are executed as SS33 illustrated in FIG. 5. In step SS48, the embodying unit 112 generates a “tangible answer” that “embodies” at least either the one or more “intangible keywords” outputted as the result of the shifting (converting) by the shift unit 109 or the “tangible sentence” generated by the contextualization unit 111.

In step SS49, the innovation detail generation unit 113 generates a detail of innovation in the business field of the user (the industry's commodity) based on at least one of the one or more “intangible keywords” outputted as the result of the shifting (converting) by the shift unit 109, the “tangible sentence” generated by the contextualization unit 111, and the “tangible answer” generated by the embodying unit 112. Thereby, the innovation creation support processing ends. As described above, when a detail of innovation is generated by using only the left side eye of the cat's-eyes illustrated in FIG. 5, YES is determined in step SS47, and a detail of innovation is generated as illustrated in step SS49. Next, details of a “device” and shifting (converting) will be described.

FIG. 15 is a diagram illustrating an example of a formula used in the innovation making processing executed by the information processing apparatus illustrated in FIG. 11.

The formula illustrated in FIG. 13 is represented as described below by equations (1) and (2).

Ai=ai(cdef) (1)

Bi=bi (2)

The item Ai represents an i-th question extracted from the question DB 181 by the question generation unit 102. Note herein that i represents an any integer value that is equal to or above 1 and equal to or below n, i.e., that falls within a range from 1 to n inclusive (n represents an any integer value of 1 or greater). The item ai represents a reply sentence by the user to the question Ai. Then, c, d, e, and f respectively represent various devices. For example, c represents “equivalent”. The service provider is able to select and determine one or more devices from among desired devices c to f. Note herein that, it is possible to select and adopt a device per question Ai. That is, for example, it is possible to adopt the device c only for a question A1, while it is possible to adopt a pair of the devices d, e for a question A2. Note that devices are not limited to the four types of c to f. That is, the service provider is able to freely select and adopt desired one or more devices from among m types (m represents an any integer value of 1 or greater) of the devices stored and managed in the device DB 182. Furthermore, Bi represents an “intangible keyword” acquired by shifting (converting) one or more keywords included in the reply sentence ai by the user. Furthermore, bi represents a generated “tangible answer” as a result of embodying through contextualization of the “intangible keyword” Bi. As described above, the service provider is able to present i types of questions A to the user and to acquire a “tangible answer” for each of the questions. Note that an example will be described below when i=1, i.e., when there is one question, when one “tangible answer” is acquired, and when a detail of innovation is generated, for purposes of description. Furthermore, as described with reference to the beehive pattern, it is possible to perform the innovation creation process a plurality of times. That is, it is possible to apply the formula a plurality of times (to perform shifting (converting) each using a device). For an example when applying the formula a plurality of times, its description is omitted.

A method of generating or updating the devices of “opposite”, “equivalent”, and “addition and subtraction” among the devices used in the information processing apparatus having the functional configuration illustrated in FIG. 11 will be described.

FIG. 16 is a diagram illustrating an example of information processing for generating or updating the device of “opposite” among the devices used in the information processing apparatus having the functional configuration illustrated in FIG. 11. As illustrated in FIG. 16, a learning set including a plurality of pairs of an input keyword and an antonym keyword is generated. That is, when a result of conversion of a predetermined input keyword using a dictionary of antonyms, for example, is referred to as an antonym keyword, a pair of the input keyword and the antonym keyword is generated. Such pairs of an input keyword and an antonym keyword as described above are generated as a learning set.

Next, when predetermined machine learning is performed based on the learning set, the learning unit generates or updates the device of opposite (an AI model) that outputs an antonym keyword when an input keyword is inputted. The device of opposite (the AI model) described above is stored and managed in the device DB 182.

The shift unit 109 uses the device of opposite (the AI model) generated or updated as described above to perform shifting (converting). Specifically, when the user has inputted an input keyword KWi, the shift unit 109 outputs an antonym keyword KWo. The outputted antonym keyword KWo is presented to the user. As described above, shifting (converting) using the device of opposite (the AI model) having undergone learning is realized.

It is possible to use feedback (FB) as described below to update the device of opposite (the AI model) having undergone learning. That is, the user evaluates the outputted antonym keyword KWo. Specifically, for example, when the user determines that the input keyword KWi acquired as a result of the shifting using the “device” of “opposite” is acceptable, the user evaluates it as “acceptable”. Furthermore, for example, when the user determines that the input keyword KWi acquired as a result of the shifting using the “device” of “opposite” is not acceptable, the user evaluates it as “unacceptable”. Note that such an evaluation may be performed by not only the user, but also the provider of the present service (the person having the knowledge about innovation). At this time, when performing an evaluation, the provider of the present service (the person having the knowledge about innovation) may perform an evaluation from a point of view of whether or not it is acceptable as shifting for innovation.

Such a set of an input keyword KWi, an output keyword KOi, and an evaluation as described above is referred to as an FB set. The learning unit uses the FB set to update the device of opposite (the AI model). Thereby, it is possible to increase accuracy of an output when using the device of opposite (the AI model).

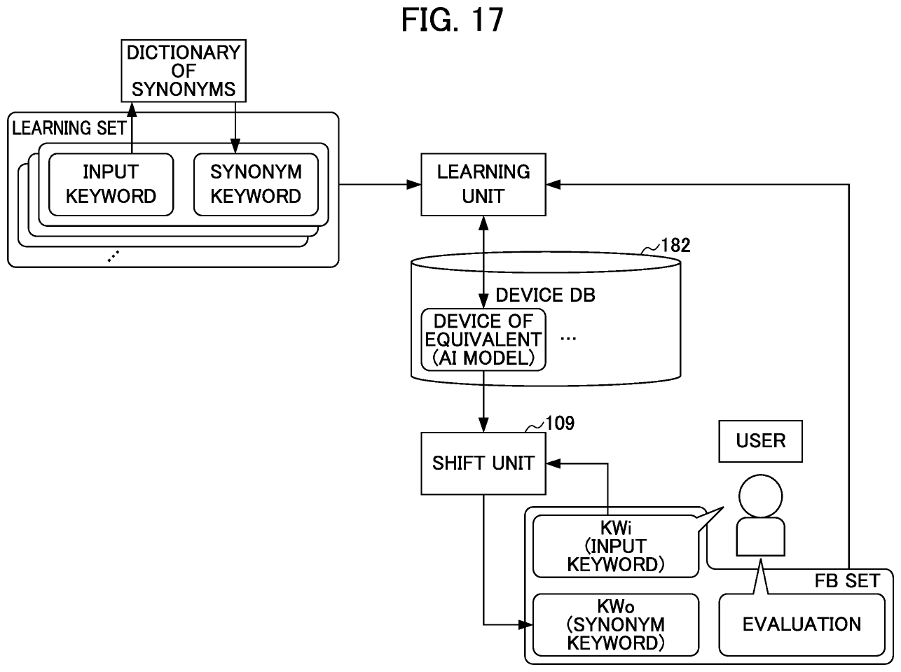

FIG. 17 is a diagram illustrating an example of information processing for generating or updating the device of “equivalent” among the devices used in the information processing apparatus having the functional configuration illustrated in FIG. 11. As illustrated in FIG. 17, a learning set including a plurality of pairs of an input keyword and a synonym keyword is generated. That is, when a result of conversion of a predetermined input keyword using a dictionary of synonyms, for example, is referred to as a synonym keyword, a pair of the input keyword and the synonym keyword is generated. Such pairs of an input keyword and a synonym keyword as described above are generated as a learning set.

Next, when predetermined machine learning is performed based on the learning set, the learning unit generates or updates the device of equivalent (an AI model) that outputs a synonym keyword when an input keyword is inputted. The device of equivalent (the AI model) described above is stored and managed in the device DB 182.

The shift unit 109 uses the device of equivalent (the AI model) generated or updated as described above to perform shifting (converting). Specifically, when the user has inputted an input keyword KWi, the shift unit 109 outputs a synonym keyword KWo. The outputted synonym keyword KWo is presented to the user. As described above, shifting (converting) using the device of equivalent (the AI model) having undergone learning is realized.

It is possible to use feedback as described below to update the device of equivalent (the AI model) having undergone learning. That is, the user evaluates the outputted synonym keyword KWo. Specifically, for example, when the user determines that the input keyword KWi acquired as a result of the shifting using the “device” of “equivalent” is acceptable, the user evaluates it as “acceptable”. Furthermore, for example, when the user determines that the input keyword KWi acquired as a result of the shifting using the “device” of “equivalent” is not acceptable, the user evaluates it as “unacceptable”. Note that such an evaluation may be performed by not only the user, but also the provider of the present service (the person having the knowledge about innovation). Furthermore, when performing an evaluation, the provider of the present service (the person having the knowledge about innovation) may perform an evaluation from a point of view of whether or not it is acceptable as shifting for innovation.

Such a set of an input keyword KWi, an output keyword KOi, and an evaluation as described above is referred to as an FB set. The learning unit uses the FB set to update the device of equivalent (the AI model). Thereby, it is possible to increase accuracy of an output when using the device of equivalent (the AI model).

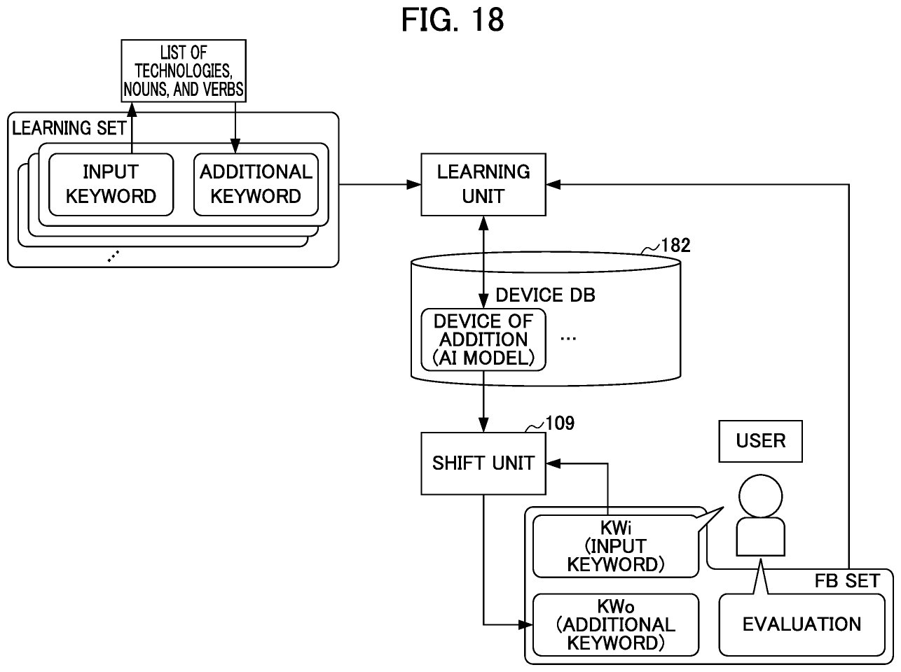

FIG. 18 is a diagram illustrating an example of information processing for generating or updating the device of “addition” in “addition and subtraction” among the devices used in the information processing apparatus having the functional configuration illustrated in FIG. 11. As illustrated in FIG. 18, a learning set including a plurality of pairs of an input keyword and an additional keyword is generated. That is, when a result of conversion of a predetermined input keyword using a list of technologies, nouns, and verbs, for example, is referred to as an additional keyword, a pair of the input keyword and the additional keyword is generated. Such pairs of an input keyword and an additional keyword as described above are generated as a learning set.

Next, when predetermined machine learning is performed based on the learning set, the learning unit generates or updates the device of addition (an AI model) that outputs an additional keyword when an input keyword is inputted. The device of addition (the AI model) described above is stored and managed in the device DB 182.

The shift unit 109 uses the device of addition (the AI model) generated or updated as described above to perform shifting (converting). Specifically, when the user has inputted an input keyword KWi, the shift unit 109 outputs an additional keyword KWo. The outputted additional keyword KWo is presented to the user. As described above, shifting (converting) using the device of addition (the AI model) having undergone learning is realized.

It is possible to use feedback as described below to update the device of addition (the AI model) having undergone learning. That is, the user evaluates the outputted additional keyword KWo. Specifically, for example, when the user determines that the input keyword KWi acquired as a result of the shifting using the “device” of “addition” in “addition and subtraction” is acceptable, the user evaluates it as “acceptable”. Furthermore, for example, when the user determines that the input keyword KWi acquired as a result of the shifting using the “device” of “addition” in “addition and subtraction” is not acceptable, the user evaluates it as “unacceptable”. Note that such an evaluation may be performed by not only the user, but also the provider of the present service (the person having the knowledge about innovation). Furthermore, when performing an evaluation, the provider of the present service (the person having the knowledge about innovation) may perform an evaluation from a point of view of whether or not it is acceptable as shifting for innovation.

Such a set of an input keyword KWi, an output keyword KOi, and an evaluation as described above is referred to as an FB set. The learning unit uses the FB set to update the device of addition (the AI model). Thereby, it is possible to increase accuracy of an output when using the device of addition (the AI model).

FIG. 19 is a diagram illustrating an example of information processing for generating or updating the device of “subtraction” in “addition and subtraction” among the devices used in the information processing apparatus having the functional configuration illustrated in FIG. 11. As illustrated in FIG. 19, a learning set including a plurality of pairs of a manual and a subtraction-target element is generated. That is, when a result of conversion of a predetermined manual using a list of technologies, nouns, and verbs, for example, is referred to as a subtraction-target element, a pair of the manual and the subtraction-target element is generated. Such pairs of a manual and a subtraction-target element as described above are generated as a learning set.

Next, when predetermined machine learning is performed based on the learning set, the learning unit generates or updates the device of subtraction (the AI model) that outputs a subtraction-target element when a manual is inputted. The device of subtraction (the AI model) described above is stored and managed in the device DB 182.

The shift unit 109 uses the device of subtraction (the AI model) generated or updated as described above to perform shifting (converting). Specifically, when the user has inputted a manual KWi, the shift unit 109 outputs a subtraction-target element KWo. The outputted subtraction-target element KWo is presented to the user. As described above, shifting (converting) using the device of subtraction (the AI model) having undergone learning is realized.

It is possible to use feedback as described below to update the device of subtraction (the AI model) having undergone learning. That is, the user evaluates the outputted subtraction-target element KWo. Specifically, for example, when the user determines that the manual KWi acquired as a result of the shifting using the “device” of “subtraction” in “addition and subtraction” is acceptable, the user evaluates it as “acceptable”. Furthermore, for example, when the user determines that the manual KWi acquired as a result of the shifting using the “device” of “subtraction” in “addition and subtraction” is not acceptable, the user evaluates it as “unacceptable”. Note that such an evaluation may be performed by not only the user, but also the provider of the present service (the person having the knowledge about innovation). Furthermore, when performing an evaluation, the provider of the present service (the person having the knowledge about innovation) may perform an evaluation from a point of view of whether or not it is acceptable as shifting for innovation.

A set of a manual KWi, a subtraction-target element KOi, and an evaluation as described above is referred to as an FB set. The learning unit uses the FB set to update the device of subtraction (the AI model). Thereby, it is possible to increase accuracy of an output when using the device of subtraction (the AI model).

Although the embodiment of the present invention has been described, the present invention is not limited to the embodiment described above. The present invention still includes amendments and modifications, for example, that fall within the scope of the present invention, as long as it is possible to achieve the object of the present invention.

For example, “approaches”, “questions”, “devices”, “intangible keywords”, “tangible sentences”, and “tangible answers” and the points of view for performing scoring, as described above in the embodiment, are mere examples.

Furthermore, for example, the flow of the innovation creation support processing illustrated in FIG. 12 is a mere example. That is, as described above, such processing is enough that a detail of “innovation” is generated based on one or more “intangible keywords” outputted as a result of shifting (converting) in step SS43. Therefore, for example, the processing of “contextualization” in step SS46 and the processing of “embodying” in step SS48 are not essential processing, and may be appropriately omitted. However, since the processing in steps SS48 and SS49 also serves as processing for generating a “tangible answer”, performing the processing in steps SS48 and SS49 is preferable in this respect.

Furthermore, for example, although the correspondence relation illustrated in FIG. 2 has included types of innovation, such a correspondence relation may be set that includes details of innovation as items. Specifically, for example, not only such a type of innovation as “product innovation”, but also such a detail of innovation as “product innovation on your company's product and disruptive innovation from a point of view of experience” may be associated, and the detail may be inferred from a reply by the user.

Furthermore, for example, questions provided to the user in the embodiment described above may not be necessary provided only for proposing a detail of “innovation” to the user. That is, questions themselves to the user may be provided for another purpose.

Furthermore, for example, it is possible to use hardware or software to execute the series of processing described above. In other words, the functional configuration illustrated in FIG. 11 is a mere example. The present invention is not particularly limited to such a functional configuration. That is, it is enough that an information processing system has functions that make it possible to wholly execute the series of processing described above. Functional blocks used to realize the functions are not particularly limited to the functional blocks illustrated in the example in FIG. 11. Furthermore, locations at which the functional blocks and databases are present are not limited to the locations illustrated in the example in FIG. 11, and may be designated as desired. For example, in the example illustrated in FIG. 11, it has been configured that the functional blocks and the databases necessary for executing various processing are included in the information processing apparatus 1. However, this configuration is a mere example. Such a configuration may be applied such that at least some of the functional blocks and the databases are included in another apparatus (for example, another non-illustrated information processing apparatus) than the information processing apparatus 1. That is, the information processing apparatus may store no databases, but may acquire various types of information from databases stored in another information processing apparatus. Furthermore, a single piece of hardware may configure one functional block. A single piece of software may configure one functional block. A combination of pieces of hardware and software may configure one functional block.

Furthermore, for example, to execute the series of processing with software, a program configuring the software is installed into a computer from a network or a recording medium, for example. The computer may be such a computer incorporated in special hardware. Furthermore, the computer may be such a computer installed with various programs used to execute various functions, such as, in addition to the information processing apparatus, a smart phone, a personal computer, or a device that varies in type, for example.

Furthermore, for example, a recording medium storing such programs as described above may not only be a non-illustrated removable medium distributed separately from a device main body to provide the programs to each user, but also be a recording medium provided to each user in a state where the recording medium is assembled beforehand in the device main body, for example.

Note that, in the present specification, steps describing programs recorded in a recording medium include not only processes sequentially executed in a chronological order, but also processes that may not necessarily be executed in a chronological order, but may be executed in parallel or separately. Furthermore, in the present specification, the term system means a generic apparatus that includes a plurality of devices and that performs a plurality of means, for example.

In other words, it is possible that the information processing apparatus to which the present invention is applied takes various embodiments having configurations described below. That is, an information processing apparatus to which the present invention is applied (for example, the information processing apparatus 1 illustrated in FIG. 11) is accessible to each of: a question storage unit (for example, the question DB 181 illustrated in FIG. 6) that is storing a plurality of questions associated with predetermined types (for example, the type of innovation of “product innovation” in the present specification) or predetermined details of “innovation” (for example, “product innovation on tissue paper and disruptive innovation pertaining to experience”); and a conversion device storage unit (for example, the correspondence relation DB 183 illustrated in FIG. 11) that is storing a plurality of types of conversion devices respectively associated with the predetermined types or the predetermined details of “innovation”, each of the conversion devices adopting a different conversion policy and each the conversion devices being a device that converts a keyword or a sentence into another keyword or another sentence according to a predetermined conversion policy. It is enough that the information processing apparatus includes: an inference portion (for example, the inference unit 107 illustrated in FIG. 11) that infers, based on a prior survey on a user, at least a portion of a type and a detail of “innovation” that the user desires; a question setting portion (for example, the question generation unit 102 illustrated in FIG. 11) that extracts a question from or that arranges the questions extracted from the question storage unit based on a result of the inference by the inference portion to set the one or more questions (for example, the question of “What is the common sense of tissue paper?” illustrated in FIG. 7); a first extraction portion (for example, the keyword extraction unit 106 illustrated in FIG. 11) that extracts a plurality of first keywords or first sentences (for example, “white”, “non-colored”, and “each piece is pulled up from above” illustrated in FIG. 7) respectively from replies by the user to the one or more questions that is or are set by the question setting portion; a second extraction portion (for example, the device determination unit 108 illustrated in FIG. 11) that extracts, from the conversion device storage unit, a conversion device (for example, the “device” of “opposite”) to be applied to the plurality of first keywords or first sentences extracted by the first extraction portion based on the result of the inference by the inference portion; a conversion portion (for example, the shift unit 109 illustrated in FIG. 11) that uses the conversion device extracted by the second extraction portion and converts each of the plurality of first keywords or first sentences extracted by the first extraction portion into each of a plurality of second keywords or second sentences (for example, “black”, “colored”, and “push up from beneath” illustrated in FIG. 7); and a contextualization portion (for example, the contextualization unit 111 illustrated in FIG. 11) that contextualizes at least a portion of the plurality of second keywords or the second sentences and generates one or more third sentences (for example, a tangible sentence of “black tissue paper that is not contained in a box” illustrated in FIG. 7).

Thereby, it is possible to manipulate information that may be an origin for creating a new business model in which innovative information appropriate for the user is reflected. Furthermore, since a sentence in which a plurality of second keywords are joined is generated as a third sentence, it is possible to easily allow the user to understand a detail of innovation.

Furthermore, a sentence setting portion (for example, the input receiving unit 104 and the input information acquisition unit 105 illustrated in FIG. 11) that sets, when a predetermined condition (for example, a condition for determining NO in step SS47 illustrated in FIG. 12) is met after the contextualization portion has generated the one or more third sentences, a plurality of fourth keywords or fourth sentences (for example, “use a paper material (pulp)”, “use black ink”, and “mill paper” illustrated in FIG. 8) based on an input operation by the user having recognized the one or more third sentences is further included, and the second extraction portion is able to extract, from the conversion device storage unit, a conversion device (for example, the “device” of “subtraction” in the example illustrated in FIG. 8) to be applied to the plurality of fourth keywords or fourth sentences based on a predetermined rule (for example, rules including a rule of following a determination by an AI model, in addition to rules based on a determination by a natural person such as a rule that a user makes a selection and a rule of following an advice provided by an innovation adviser), the conversion portion is able to use the conversion device extracted by the second extraction portion and to convert each of the plurality of fourth keywords or fourth sentences into each of a plurality of fifth keywords or fifth sentences (for example, “use waste paper”, “subtract black ink”, and “thinly mill paper” illustrated in FIG. 8), and the contextualization portion is able to contextualize at least a portion of the plurality of fifth keywords or the fifth sentences and to generate one or more sixth sentences (for example, a tangible sentence of “use waste paper and subtract ink in amount”).

Furthermore, when the predetermined condition is met after the contextualization portion has generated the one or more sixth sentences, the first extraction portion, the second extraction portion, the conversion portion, and the contextualization portion are able to repeatedly execute each step of the processing according to claim 2 (for example, repeatedly execute the right side eye in the cat's eye pattern illustrated in FIG. 5).

A scoring portion (for example, the scoring unit 110 illustrated in FIG. 11) that performs scoring on each of the plurality of second keywords or second sentences converted by the conversion portion from a predetermined point of view is further included, and the contextualization portion is able to take into account a result of the scoring by the scoring portion and to execute contextualization.

Thereby, the value of each of the second keywords is recognized, and contextualization is executed by taking into account a highly valuable second keyword. As a result, it is possible to manipulate information that may be an origin for creating a new business model in which innovative information appropriate for the user is reflected.

### EXPLANATION OF REFERENCE NUMERALS

1 Information processing apparatus, 11 CPU, 18 Storage unit, 101 Approach setting unit, 102 Question generation unit, 103 Display control unit, 104 Input receiving unit, 105 Input information acquisition unit, 106 Keyword extraction unit, 107 Inference unit, 108 Device determination unit, 109 Shift unit, 110 Scoring unit, 111 Contextualization unit, 112 Embodying unit, 113 Innovation detail generation unit, 114 Device generation unit, 181 Question DB, 182 Device DB, 183 Correspondence relation DB

It is claimed:

1. An information processing apparatus that is accessible to each of:
a question storage unit that stores a plurality of questions associated with predetermined types or predetermined details of “innovation”; and
a conversion device storage unit that stores a plurality of types of conversion devices respectively associated with the predetermined types or the predetermined details of “innovation”, each of the conversion devices adopting a different conversion policy and each the conversion devices being a device that converts a keyword or a sentence into another keyword or another sentence according to a predetermined conversion policy,
the information processing apparatus comprising:
an inference portion that infers, based on a prior survey on a user, at least a portion of a type and a detail of “innovation” that the user desires;
a question setting portion that extracts a question from or that arranges the question extracted from the question storage unit based on a result of the inference by the inference portion to set the one or more questions;
a first extraction portion that extracts a plurality of first keywords or first sentences respectively from replies by the user to the one or more questions that is or are set by the question setting portion;
a second extraction portion that extracts, from the conversion device storage unit, a conversion device to be applied to the plurality of first keywords or first sentences extracted by the first extraction portion based on the result of the inference by the inference portion;
a conversion portion that uses the conversion device extracted by the second extraction portion and converts each of the plurality of first keywords or first sentences extracted by the first extraction portion into each of a plurality of second keywords or second sentences; and
a contextualization portion that contextualizes at least a portion of the plurality of second keywords or the second sentences and generates one or more third sentences.

2. The information processing apparatus according to claim 1, further comprising a sentence setting portion that sets, when a predetermined condition is met after the contextualization portion has generated the one or more third sentences, a plurality of fourth keywords or fourth sentences based on an input operation by the user having recognized the one or more third sentences,
wherein the second extraction portion extracts, from the conversion device storage unit, a conversion device to be applied to the plurality of fourth keywords or fourth sentences based on a predetermined rule,
the conversion portion uses the conversion device extracted by the second extraction portion and converts each of the plurality of fourth keywords or fourth sentences into each of a plurality of fifth keywords or fifth sentences, and
the contextualization portion contextualizes at least a portion of the plurality of fifth keywords or the fifth sentences and generates one or more sixth sentences.

3. The information processing apparatus according to claim 2, wherein, when a predetermined condition is met after the contextualization portion has generated the one or more sixth sentences,
the first extraction portion, the second extraction portion, the conversion portion, and the contextualization portion repeatedly execute each step of the processing according to claim 2.

4. The information processing apparatus according to claim 1, further comprising a scoring portion that performs scoring on each of the plurality of second keywords or second sentences converted by the conversion portion from a predetermined point of view,
wherein the contextualization portion takes into account a result of the scoring by the scoring portion and executes contextualization.
